(19) United States
(12) Patent Application Publication
(10) Pub. No.: US 2016/0104471 A1
(43) Pub. Date: Apr. 14, 2016

(54) Musical instrument, which comprises chord triggers, that are simultaneously triggerable and that are each mapped to a specific chord, which consists of several musical notes of various pitch classes

(71) Applicant: Christopher Michael Hyna, Bamberg (DE)

(72) Inventor: Christopher Michael Hyna, Bamberg (DE)

(21) Appl. No.: 14/875,718

(22) Filed: Oct. 6, 2015

(30) Foreign Application Priority Data
Oct. 8, 2014 (DE) 10 2014 014 856.4

(51) Int. Cl. G10H 1/38; G10H 1/28

(52) U.S. Cl. CPC G10H 1/386; G10H 1/28

(57) ABSTRACT

A musical instrument, which comprises chord triggers and outputs a chord, wherein various chords like C-diminished, F-minor, D-major we provided for example, with means which differently highlight certain chord triggers to help the user while playing. Those chord triggers are highlighted, whose triggerable chord is in a certain relationship with a note repertoire which is previously set. This note repertoire, for example, could be a note scale like F-major or G-sharp-Spanish. If the chord of a chord trigger and a previously set note repertoire do match on enough common pitch classes or if the chord of a chord trigger doesn't have too much pitch classes which don't match the pitch classes of the common note repertoire, that chord trigger gets highlighted, to show the relationship to the user.

Musical instrument, which comprises chord triggers, that are simultaneously triggerable and that are each mapped to a specific chard, which consists of several musical notes of various pitch classes

It is known to provide chord triggers in a musical instrument which simultaneously outputs musical notes of different pitch classes by triggering a chord trigger. These musical instruments have both: On the various chord triggers, they have mapped specific chords of different root notes, as well as mapped specific chords of at least three different chord types. So you always need at least three different chord types to be able to play the right triad for each degree of a major or minor scale.

An example of this may be the major scale whose degrees 1, 4 and 5 have a major chord and whose degrees 2, 3 and 6 have a minor chord, but the 7th degree has a diminished chord. These instruments are able to simultaneously provide this diversity of chord triggers with mapped specific chords without the necessity of selecting or arranging them before.

In this situation it is, however, for the layman not clear which mapped specific chords of the chord triggers consist of which musical notes and even not, which mapped specific chords of the chord triggers match on common pitch classes related to the mapped specific chords of other chord triggers or which mapped specific chords of the chord triggers fit to a specific scale or to a specific chord progression.

This is only possible if you know which specific chord is mapped to which chord trigger and if you know of which musical notes these specific chords are constructed and if you can quickly calculate the relations of common pitch classes or if you learned them by heart.

The object of the present invention is to provide a musical instrument that indicates the musical-mathematical set relationships of the specific chords, which are mapped to the chord triggers, to the user, in order to play with the musical instrument by musical-mathematical set relationships even without knowledge of music theory and mathematical talent.

This problem is solved by . . . :
means which put 80-100% of the set of the simultaneously triggerable chord triggers of the musical instrument in the state, in which those chord triggers,

whose mapped specific chord fulfills a common mathematical inequality, which compares a threshold with the cardinality of the intersection of the pitch classes of the mapped specific chord and the pitch classes of a common note repertoire,

are highlighted distinguishably differently from the chord triggers whose mapped specific chord does not fulfill this inequality.
means which put 80-100% of the set of the simultaneously triggerable chard triggers of the musical instrument in the state, in which those chord triggers,

whose mapped specific chord fulfills together with at least one common note repertoire out of a group of common note repertoires a common mathematical inequality, which compares a threshold with the cardinality of the intersection of the pitch classes of the mapped specific chard and the pitch classes of a common note repertoire out of a group of common note repertoires,

are highlighted distinguishably differently from the chord triggers whose mapped specific chord does not fulfill this inequality,

wherein the common note repertoire includes up to five pitch classes,

wherein the group of common note repertoires is not changeable by triggering a chord trigger.
means which put 80-100% of the rectangular inclusion set in that state, in which those chord triggers.

whose mapped specific chord fulfills a common mathematical inequality, which compares a threshold with the cardinality of the intersection of the pitch classes of the mapped specific chord and the pitch classes of a common note repertoire.

are highlighted distinguishably differently from the chord triggers whose mapped specific chord does not fulfill this inequality.

The advantages achieved with the invention are in particular, that instead of learning the musical-mathematical set relationships by heart or the alternative of spontaneous fast calculating the set relationship of different note sets (in this case, between on the one hand the mapped specific chords of the chord triggers and on the other hand other specific chords or specific scales of the common note repertoire), and, that these tasks are processed by a device and their results are presented by a device, so you can immediately intuitively play by just following the highlighting and following your ears without previous knowledge.

The invention also has an educational effect and teaches the player the relationships of the sets while playing. The chord triggers whose mapped specific chords have enough matching pitch classes with the common note repertoire get highlighted distinguishably differently and are directly indicated to the user by this way. The user can still choose whether he wants to follow the suggestions or wants to trigger a chord trigger, which is not suggested by the distinguishably different highlighting.

In addition, the user can play improvised chord progressions faster than on other instruments by the help of the invention, because he needs to consider less time.

The margin of 80-100% should keep the possibility, based on a rule of the common mathematical inequality, of allowing highlight deviations, to refresh the play, for example by random false highlighting states of 0-20% of the chord triggers, to make every moment of highlighting more unique by such a little random variation and so to minimize possible repetitions and recurring cycles and to be allowed to additionally illuminate specific chord triggers because of their harmonic function, even if the match of the pitch classes is not strong enough, but if musical listening habits justify to necessarily suggest certain chord triggers.

The subject matter of claim 9 has the further advantage that the harmonic space of several related chords is made clear. Thus, one has the possibility, if the chords of existing songs are included in a note repertoire group of the musical instrument, to easily accompany or remix this existing song. So also chord triggers can be highlighted, to which such specific chords are mapped, which are similar to the actual specific chords of the existing song, to additionally use these chords as an alternative to the actual chords of the existing song, and so to be able to apply a chord substitution. Thereby you can change the chord structure of the existing song, even as a layman. Just like an electronic musician who samples the chords of an existing song from an audio medium, who stores that in the memory of a sampler and who maps it to the sample triggers of a sampler, one has here this helping harmony restriction by the highlightings, but with a particular advantage, that the created musical notes are potentially separately editable and that in addition to the mapped specific chords of distinguishably differently highlighted chord triggers of the existing song you can output many other specific chords by triggering, which are not included in the existing song, unlike the sampled chord audio data of an existing song.

The subject matter of claim 13 has the advantage, that adjacent chord triggers can be highlighted by the common mathematical inequality, while other chord triggers can be not highlighted or can be highlighted by different principles, so other approaches become possible for the user by the plurality of highlighting rules of distinguishable groups of chord triggers, but without mixing, thereby reducing intelligibility. It is important that the user can understand, despite the plurality through the rectangular inclusion, that at a specific location on the user interface, namely within the rectangle, the chord triggers are highlighted by a common rule, that is the common mathematical inequality. If the chord triggers that obey a rule, would be scattered, instead of being inside the rectangle, it would be very difficult for the user to distinguish them from those who do not follow the rule. Thus, the user could get no help from the highlighting.

The subject of claim 15 has the further advantage that it is ensured by the larger rectangular inclusion set that a larger continuous area of chord triggers is helpfully highlighted according to the characterizing portion of claim 13.

The subjects of the claims 7, 8, 12, 16 relate to the display's precision of the musical instrument.

The subject matter of the claims 3, 11, 17 has the advantage that the user can understand and predict, which sound will be output by triggering a chord trigger, by the indices before triggering. Even the layman quickly learns this with the musical instrument of the present invention. The educational impact is, above all, that the user learns to abstract the indices, in other words he learns how a minor chord type, for example, sounds, so he leans what characterizes the set of all minor chords. Matrices of higher dimension are good to increase the musical expressivity.

The subject matter of the claims 2 and 14 has the advantage that the common mathematical inequality is limited to the three clearest, most important species, and combinations thereof. In the first combination it is checked what percentage of pitch classes of the mapped specific chord match with the common note repertoire, in the second combination it is checked, how many pitch classes of the mapped specific chord may be missing in the common note repertoire, and the third combination will determine how high the absolute number of the intersection of the pitch classes of on the one hand the mapped specific chord and on the other hand the common note repertoire must be at least.

Thus, the three insightful perspectives and their three combined perspectives are possible on the relationship of the sets by the six defined mathematical inequalities.

The subject matter of the claims 6, 10, 18 recommends the most preferred way of comparing the mapped specific chord of each chord trigger and the common note repertoire in a percentage way. Because by this percentage method the mapped specific chords of the chord triggers with many pitch classes and those with few pitch classes are equally treated in their relationship of matching.

Thus, the extent of harmony and disharmony remains the same when triggering the equally highlighted chord triggers, no matter how many pitch classes the mapped specific chord has, unless it exceeds the pitch class number of the common note repertoire. From there it increasingly becomes unbalanced.

The subject matter of the claims 4 and 19 has the further advantage that the three main chord types of western music are available, which are the chords that you need to form the triad on each degree for a major or minor scale. The more precise definition of the common note repertoire only allows note sets which already occur as commonly used phenomena in music, thus guaranteeing a better functioning with listening habits. In addition, the visual highlighting is the absolute ideal way which is explained in the end of the description by accurate reasons. In addition, buttons are a good version of chord triggers because they have proven themselves in the past of the musical instruments and users are familiar with them by their usage of musical instruments and thus user find a quick access.

The subject matter of claim 5 has the advantage of being able to determine more different note repertoires at different times to enhance the musical spectrum. There are musical instruments known, in which only common note repertoires are determinable, which only differ in transposition. So for scales you can set up for example, only every church scales. The Spanish or Arabic or Hungarian scale type differ more than just in their transposition compared to the church scales, which include the major and minor scale. If you want to have the ability to determine on the one hand a specific scale like the C-major scale as common note repertoire, but on the other hand also a specific chord like the C-major chord, you have therefore already two common note repertoires which differ in more than their uniform transposition. Thus, the diversity of the common note repertoire can be extremely enlarged.

In the following, the invention is differentiated from publications and products. It is started with those which correspond to the prior art portion.

The “Omnichord” of “Suzuki Musical Instrument” and “Camidion” of “Akiyoshi Kamide” possess the features of the prior art portion, however, they don't possess a single feature of the characterizing portion of the main claim and the independent claims. In addition, both do not correspond to the dependent claims 6, 10 and 18.

Accordions with Stradella Bass system or the electric organ from the U.S. Pat. No. 2,645,968 are known. They provide the features of the prior art portion, but in no way those features of the characterizing portion.

Although the tablet app “Rechorder” from “Arts Unmuted” also provides chord triggers with more than two different chord types on different root notes which are simultaneously triggerable. However, the app highlights only the chord triggers whose root is found in a selected common note repertoire. Other chord triggers, whose mapped specific chord possesses at least one musical note in this common note repertoire will not be highlighted if no musical note of those is the root note, although such chord triggers precisely match the same number of musical notes of the same pitch class with the common note repertoire. The invention takes off and improves this state of affairs, because a triad, for example, whose root note is in contrast to the rest of the musical notes of the triad a part of a note repertoire, usually has far less benefit to a progression concerning this note repertoire than another triad in whose all musical notes except the root not are included in this note repertoire. Claim 2 and 14 are therefore not fulfilled.

The software for Monome namely “Harmonome” of “52 patches” also provides chord triggers of more than two different chord types on different root notes, which are simultaneously available. However, the software on the one hand only permanently highlights the chord triggers with a single selected root note and an the other hand only the pressed chord trigger itself and all those which exactly correspond to the musical notes of the chord trigger just pressed, which means having no more and no less musical notes, which is not the idea of the main claim, and not the idea of an inclusion of 100% of the mapped specific chords of the chord triggers in a common note repertoire which might be defined here by the just triggered note set, because then even chord triggers would be highlighted, whose mapped specific chord would be only a subset of the common note repertoire, that means those chord trigger's musical notes would be all part of the common repertoire note, while these chord triggers do not include all musical notes of the common note repertoire. An example of this is that if C-major7 is pressed, not the chord triggers of C-major are highlighted in the “Harmonome”, although the C-major chord is completely part of C-major7. The software therefore has no kind of set relationship like defined in the main claim, but only highlights chord triggers with the same function as the currently triggered chord trigger. Claim 2 and 14 are not fulfilled.

The software “Accord” of “Ewan Hemingway” for Monome also provides chord triggers with more than two different chord types on different root notes which are simultaneously available, but it only highlights the chord triggers that are being triggered. Just like with the “Harmonome” those chord triggers are not highlighted, which have three pitch classes mapped for triggering, while these three mapped pitch classes are for 100% contained in a currently output specific chord of four pitch classes. Thus. “Accord” does not fulfill as well the main claim or independent claim, because it fulfills none imaginable inequality. Claim 2 and 14 are not fulfilled.

The VSTi “Harmony improviser” of “Synleor”, the tablet apps “Polychord” of “Shoulda Woulda Coulda” and “EzComposer” of “Yeinart” and the “Novation Launchpad” program “Allchords” of “Sound Temple” do also highlight chord triggers with more than two different chord types on different root notes which are simultaneously available. They do it not according to mathematical set relationships, but by other rules, which do not follow logical comparisons of the pitch classes.

Therefore the user can't get any knowledge and thus the system is not transferable to any mapped specific chords of chord triggers and common note repertoires or adjustable. They all do also not fulfill claim 5. “Allchords”. “Harmony improviser” and “Polychord” provide no matrix, in which several indices are consistently combined.

Now some competitors are mentioned which do not possess all the features of the prior art portion.

The tablet app “Enchord” of “Avantgarde Sound” also provides chord triggers with mapped specific chords of more than two different chard types which are simultaneously available, and highlights the chord triggers whose pitch classes of the mapped specific chords are all included in the common scale note repertoire, while all have the same root note and do not provide mapped specific chords, which are simultaneously available on different root notes, like it's defined in the main claim. Thus only very monotonous play is possible. While it is true that specific chords of different root notes can be assembled in a different screen of the program, they are no longer highlighted by their subset quality concerning a specific scale. In addition, no velocity can be generated due to the touch screen, which immensely depreciates the musical expressivity. While it is true that the chord triggers are arranged like a table, however, the mapped specific chords are mapped without system and do not follow any logical combination of two indices as claimed in claim 3, 11 and 17. In addition, “Enchord” does not fulfill the claims 2 and 14.

Although the Android app “Easy Chords Studio” from “Torx Entertainment” also provides chard trigger on different root notes which are simultaneously available, and highlights the chord triggers whose mapped specific chords are with all their three pitch classes included in the common note repertoire, it only provides specific chords an two different chard types major & minor, so only a fairly monotonous play is achievable and also the basic triads of each degree are not available for any heptatonic scale type because the diminished chord, which is always the 7th degree for the major scale type and always the 2nd degree for the minor scale type, is not available in this app.

Furthermore, only common note repertoires are choosable which are identical except for their transposition to each other, because only major and minor scales are available and every major scale has a relative minor scale with which it shares the exact same set of pitch classes such as C-major and A-minor. However, claim 5 claims for more. In addition “Easy Chord Studio” does not fulfill to claims 4 and 19, because it can only output the chord types major and minor.

Also, none of the competing examples cited fulfill the characterizing portion of claim 9.

In addition the special terms are explained, which are used in the claims and the description, so that they can be better understood.

The pitch class is the set of all musical notes, whose frequencies are in relation of “2 by the power of n”, where “n” is a natural number. That means, for example, each C, each D double flat, each B sharp, every A triple sharp, and so on belongs to the same pitch class. The pitch class “C” is the set of all musical notes C, in whatever octave they are located. So musical notes of the same note letter and its enharmonic changes are of a same pitch class. So in the chromatic system there are 12 pitch classes. The pitch classes must not only be linked to the 12 pitch classes of the chromatic system, but can also be pitch classes of other pitches. You could for example take a look at the pitch class of a musical note, which is exactly in the middle between E and F, which would then have approximately 339.428 Hz. All music would then belong to this pitch class whose frequency is the product of “339.428 Hz” and “2” to the power of any natural number “n”, what is “339.428 Hz times 2 to the power of n”. Of course small variations of the pitch don't matter for the present invention as long as the sound can still be perceived as the same musical note. So not only exactly 339.428 Hz, but the area round about 339.428 Hz, which is perceivable as equally sounding, is decisive for the assignment to this pitch class.

The scale type is not made of specific musical notes, but only from the information, in which intervals the other musical notes of the scale type are set to their root note. Examples of scale types are major, minor, Spanish, Phrygian.

The specific scale consists of the information of the scale type and of the information of the root note. So it exactly defines which pitch classes belong to the scale. Examples of specific scales are eg C-major, F-minor, Dis-Spanish, G-Phrygian.

The chard trigger is an element of any kind, which can be triggered by the user and its trigger can be captured by the musical instrument to output the mapped specific chord of a chord trigger after triggering it.

The chord type defines the number and the interval of the remaining musical notes to the root note. Examples of chord types are minor (=root note+minor third+perfect fifth), minor third (=root note+minor third), m7 (=root note+minor third+perfect fifth+minor seventh).

The root note is that musical note, which is the base for the interval relationships of the other musical notes of a chord type or scale type. If you define a root note for a scale type, you get a specific scale as result, if you define a root note for a chord type, you will get a specific chord as result. Examples of the root note are C, F. B.

By the term specific chord any polyphonic sound is meant, which comprises specific musical notes of at least two different pitch classes: Thus, dyads are covered as well by the this term of chord in here. A layering of thirds as the term triad is usually used in music theory, matches most usual chords, but is not essential to the concept of a chord used in the context of the present invention. By chords not only exactly simultaneously output musical notes are meant, but also their arpeggios. The specific chord results from the combination of chord type and root note.

Examples of specific chords are C-minor, F-minor-third, B-m7.

The common note repertoire is a pitch classes' set of a specific scale or a specific chard, which is compared with the pitch classes of the mapped specific chord of each chord trigger to calculate their set relationship. Examples of the cardinality of the pitch classes of common note repertoires can be the following:

Scales as C-major (cardinality 7) or F-pentatonic (cardinality 5) or chords like F-maj7 (cardinality 4), while a power chord has only the cardinality of 2, because its octave interval adds no new pitch class.

Highlighting is a differentiation or a mark of any kind, which is perceivable by the user and can be associated to the chard triggers by him. It allows him to separately perceive the highlighted chord triggers from the rest of the chord triggers.

A group of chord triggers is also defined as highlighted distinguishably differently, if only this group of chord triggers is not highlighted in contrast to the remaining chord triggers.

As highlighted distinguishably differently is defined: Each group of chord triggers whose every chord trigger is highlighted distinguishably differently from any element existing outside the group, while it is not mandatory for a highlighted group, that its members must be uniformly highlighted in all aspects among themselves, as long as their uniformity is expressed through their difference to the rest. This uniformity or difference concerning highlighting may refer to various properties such as color, pattern, light intensity, vibration intensity, vibration frequency, flashing frequency, movement, to name just an extract of a few examples.

Of course, “highlighted distinguishably differently” does not mean the state in which all, or none chord triggers are highlighted. Because if all chord triggers are uniformly highlighted, no chord trigger is highlighted distinguishably differently.

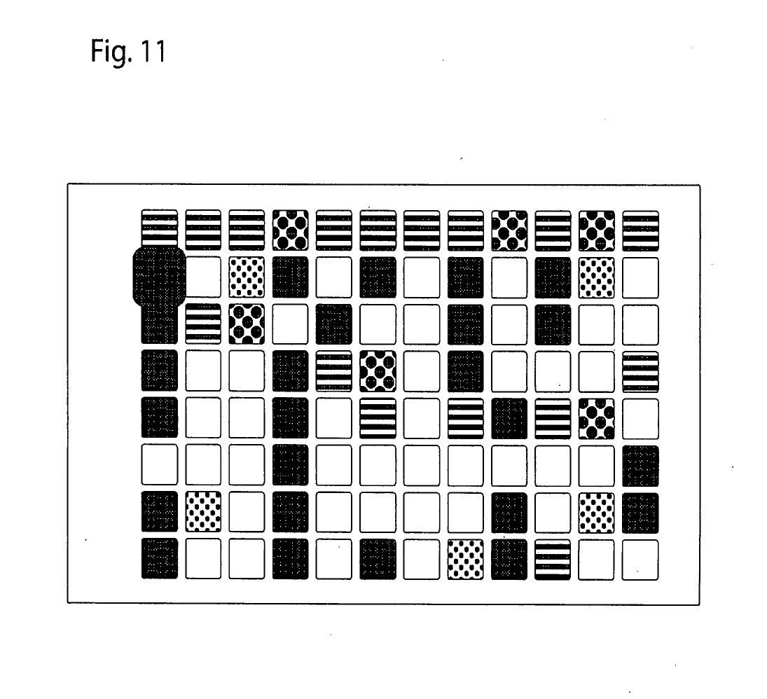

For example, in FIG. 11 all uniformly highlighted chard triggers 500, 501, 502, 503, 504 rate as separately highlighted to each other, as well as all combinations of the set unions of these uniformly highlighted chord triggers' sets, such as:

500∪501

500∪502

502∪503∪504

500∪501∪502∪503∪504

and so on

Altogether there are in FIG. 11 namely 31 possible set unions that may rate as highlighted distinguishably differently. When counting the individual sets, you get 36 sets, which may rate as highlighted distinguishably differently.

Triggering is the act of actuating, activating, the act where a person is involved and where the person interacts with the interface, wherein the result of processing is not included, even not the result of outputting of a mapped output function like outputting a mapped specific chord. Triggering is independent of polling a trigger and independent of being registered by the apparatus. Through the technique of multiplexing for example, the simultaneous registering of triggering is not possible, although simultaneous triggering is possible. For the invention, this means that triggering is an act before the outputting of the musical notes, and even before the registering of triggering by the musical instrument. For the claims that means that simultaneous ability of triggering is not equal with simultaneous ability of outputting. In the case of the embodiment example of the detailed description, this means that you can touch and push two buttons at the same time, which are mapped to certain output functions, while the output signal has not to be simultaneously put out, because it can be dependent on a programmed loop that polls via multiplexing Unless the musical instrument is electrical or acoustical. Then simultaneous output is also possible.

If you have to reconfigure the chord triggers before, to trigger chord triggers of desired other specific chords, these desired chord triggers of other specific chords are not simultaneously triggerable together with the chord triggers with specific chords, which where available before the reconfiguration and thus both are not simultaneously triggerable chord triggers.

As explanation of the tables in FIG. 24, 25, 26, 27, 28, 29, the following is intended to help.

A=chord trigger

Note1 to Note4=the chord trigger's mapped MIDI notes 1 to 4

|A|=Cardinality of the pitch classes of the mapped specific chord of the chord trigger

|A∩Vsk|=Cardinality of the intersection of the pitch classes of the mapped specific chord of the chord trigger and the common scale note repertoire

|A∩Vah|=Cardinality of the intersection of the pitch classes of the mapped specific chord of the chord trigger and the common adhoc note repertoire

from |A∩Vpl| to |A∩Vpl|=Cardinality of the intersection of the pitch classes of the mapped specific chord of the chord trigger and the common song preset note repertoire 1 to 6

green=color code for green LED

blue=color code for blue LED

red=color code for red LED

In the following, with reference to the attached drawings the embodiments of the present invention will be described

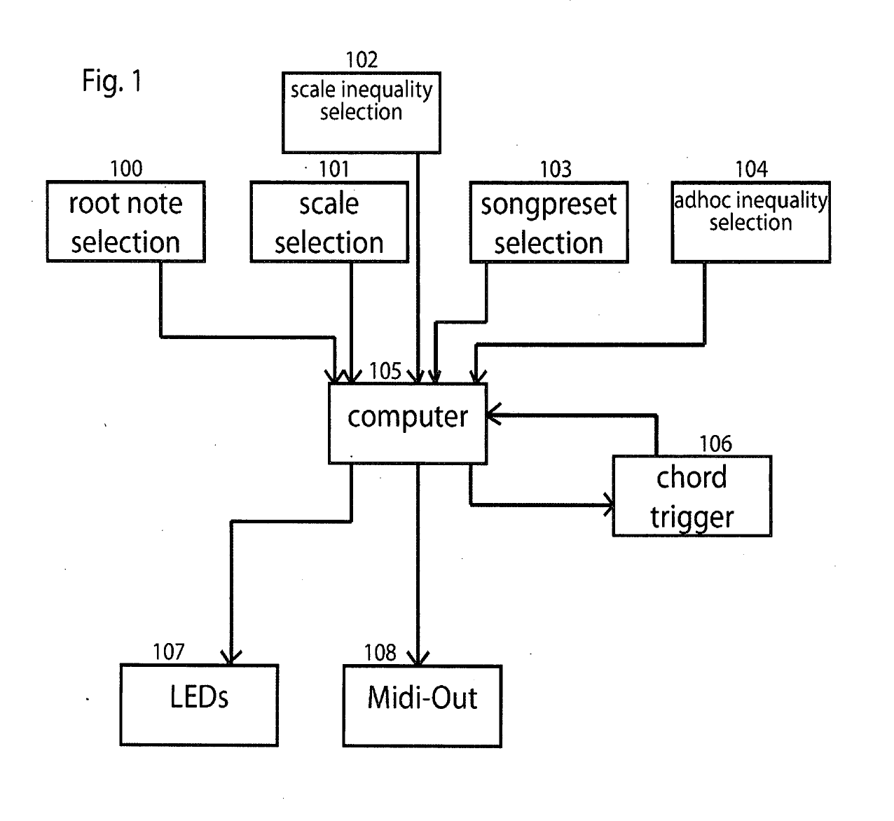

FIG. 1 shows a circuit's scheme with the computer 105 as the center and all signal paths.

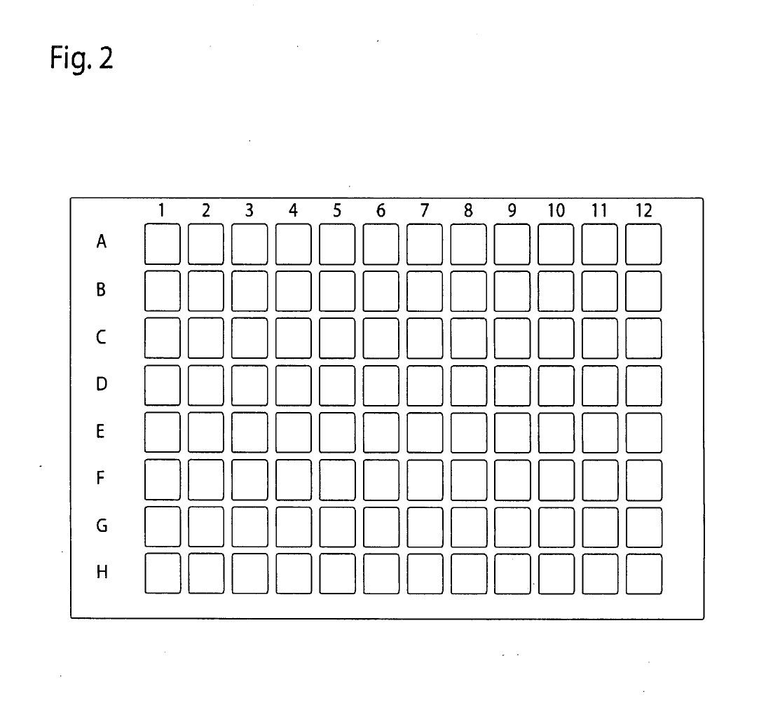

FIG. 2 shows the user interface of the musical instrument with 8×12 chord triggers, wherein the indices of the values from A to H and from 1 to 12 are conflated and thus the chord triggers get names like A1, A2, A3 get to H12

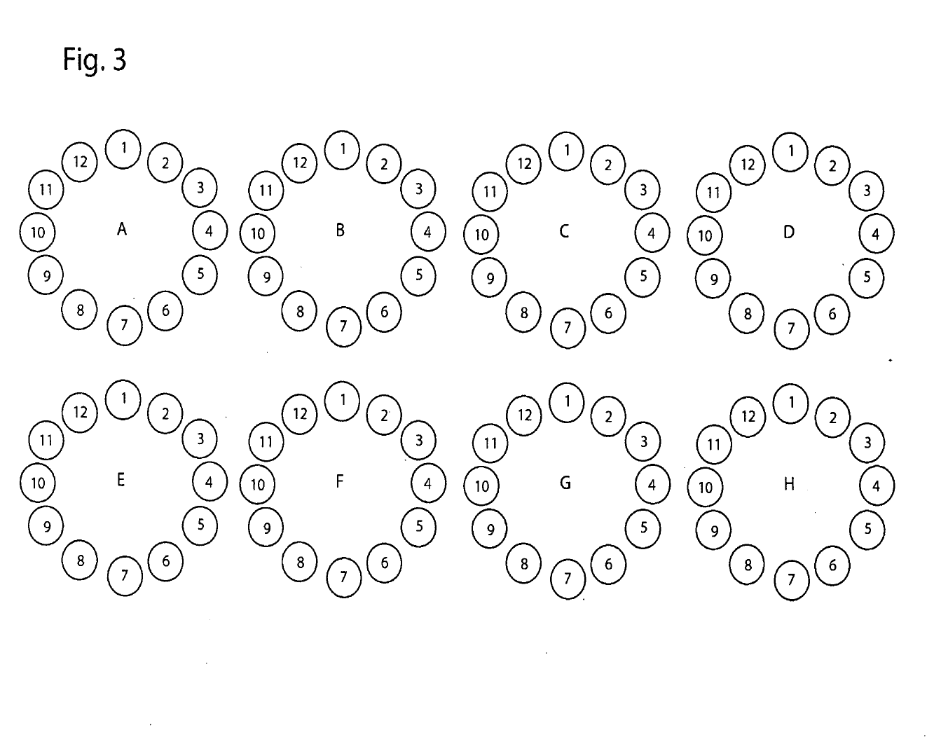

FIG. 3 shows an alternative user interface of the musical instrument with 8×12 chord triggers, wherein the indices of the values from A to H and from 1 to 12 are conflated and thus the chord triggers get names like A1. A2, A3 get to H12

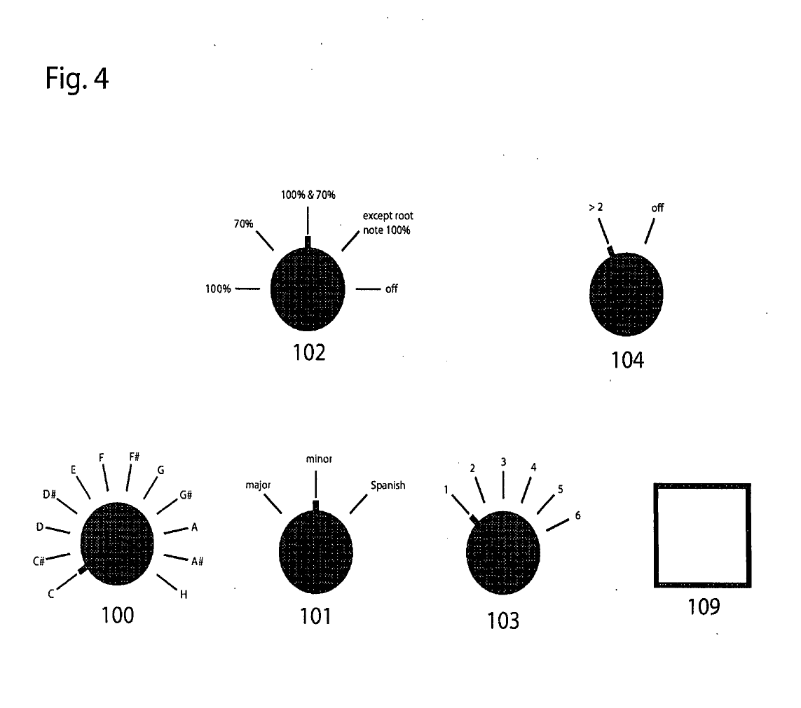

FIG. 4 shows the switch of the selections and the alt-button

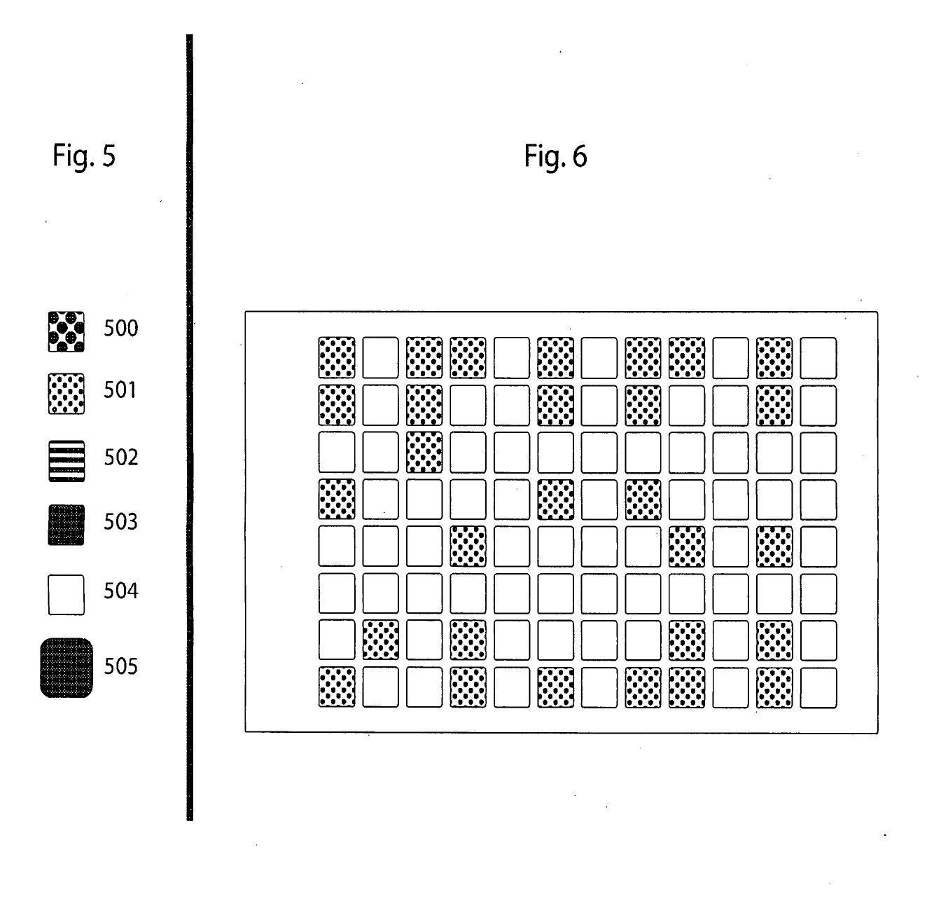

FIG. 5 shows the 6 different types of highlighting amid assigns them to the identification numbers

FIG. 6-12 show each snapshots of the user interface and are described later in more detail

FIG. 13 shows a sample of the C-alt-table which is stored in the computer 105 amid can serve as a starting point

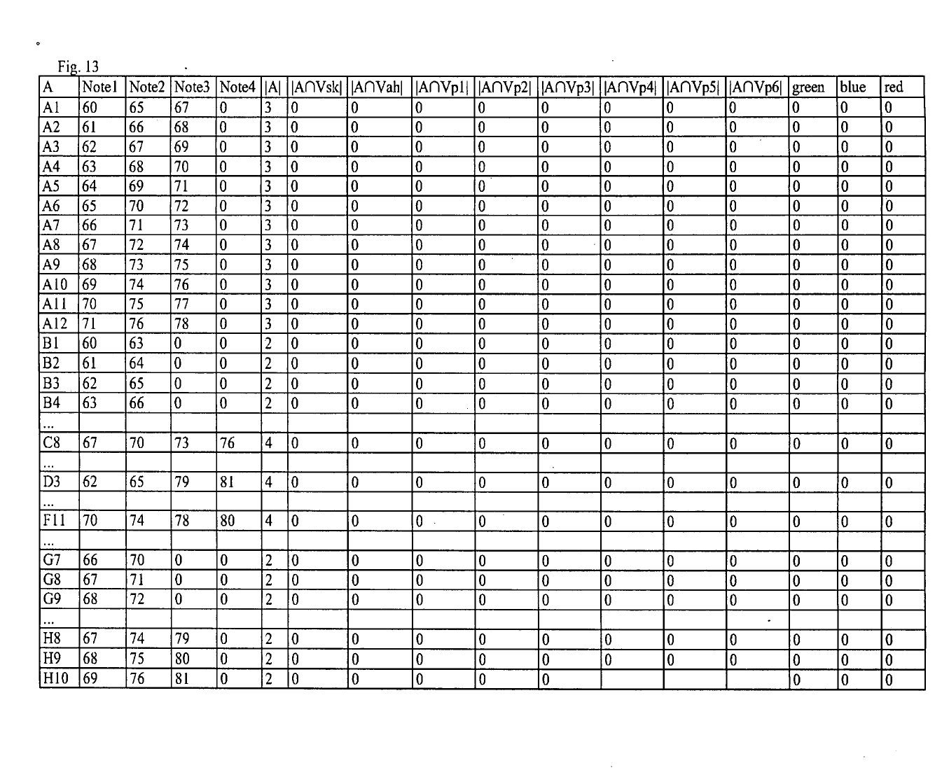

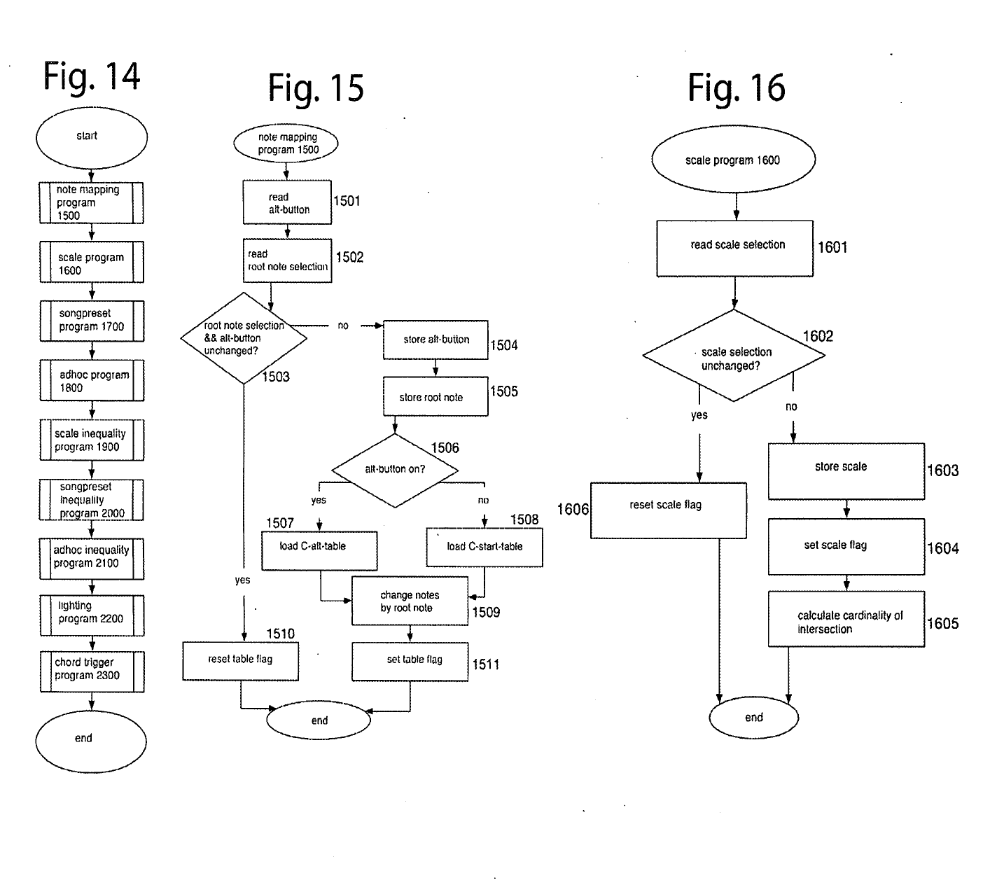

FIG. 14 shows the main program of the embodiment

FIG. 15 shows the sub program “note mapping program”

FIG. 16 shows the sub program “scale program”

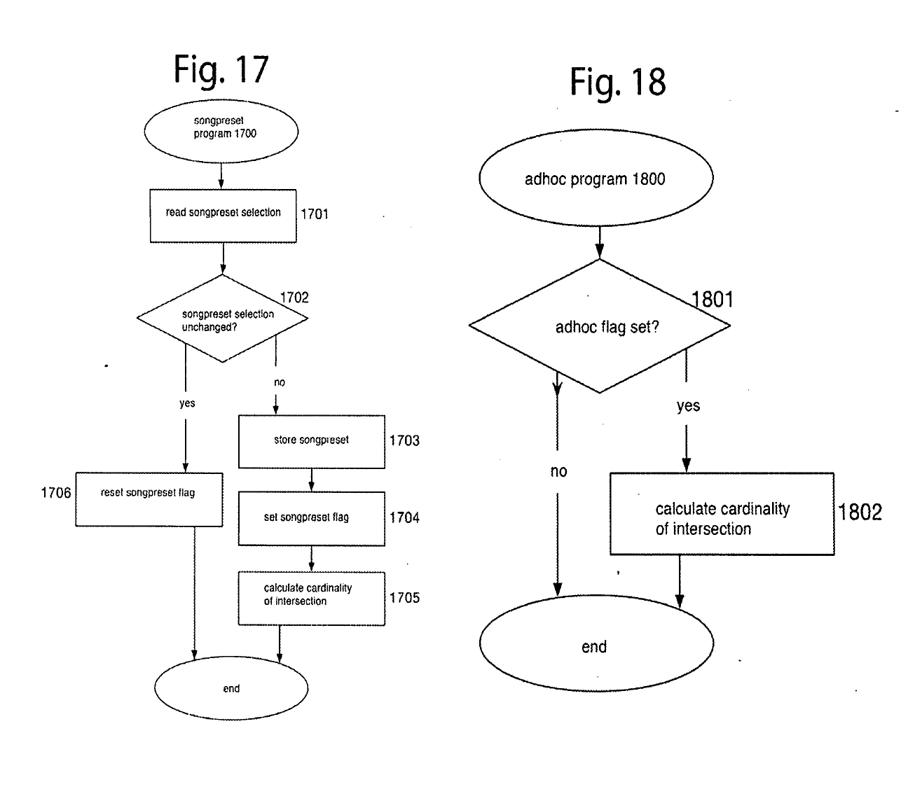

FIG. 17 shows the sub program “songpreset program”

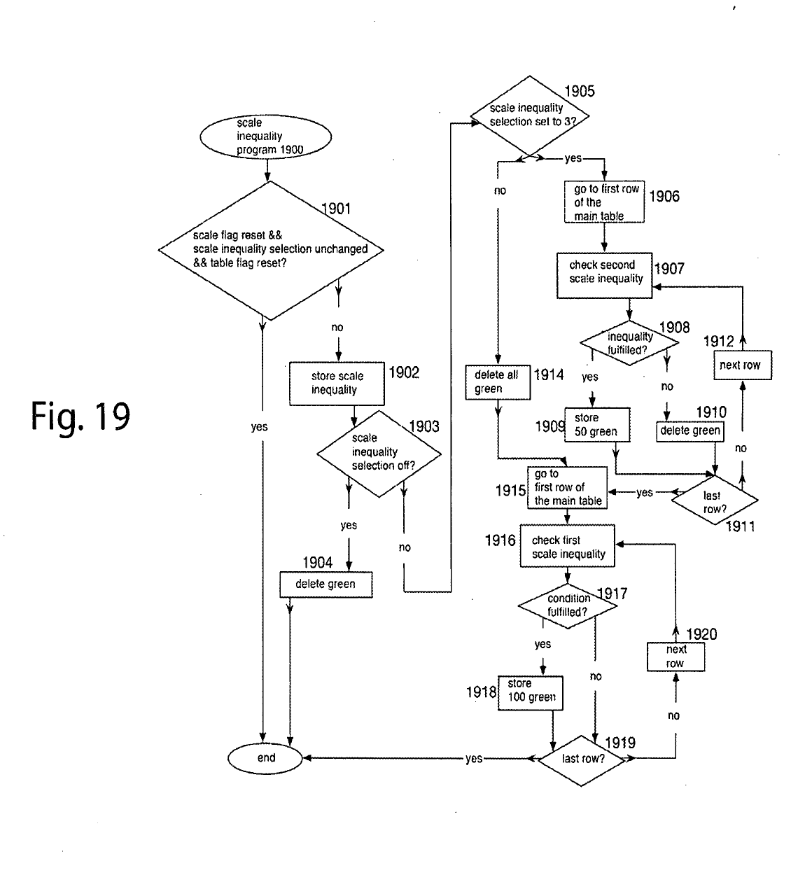

FIG. 18 shows the sub program “adhoc program”

FIG. 19 shows the sub program “scale inequality program”

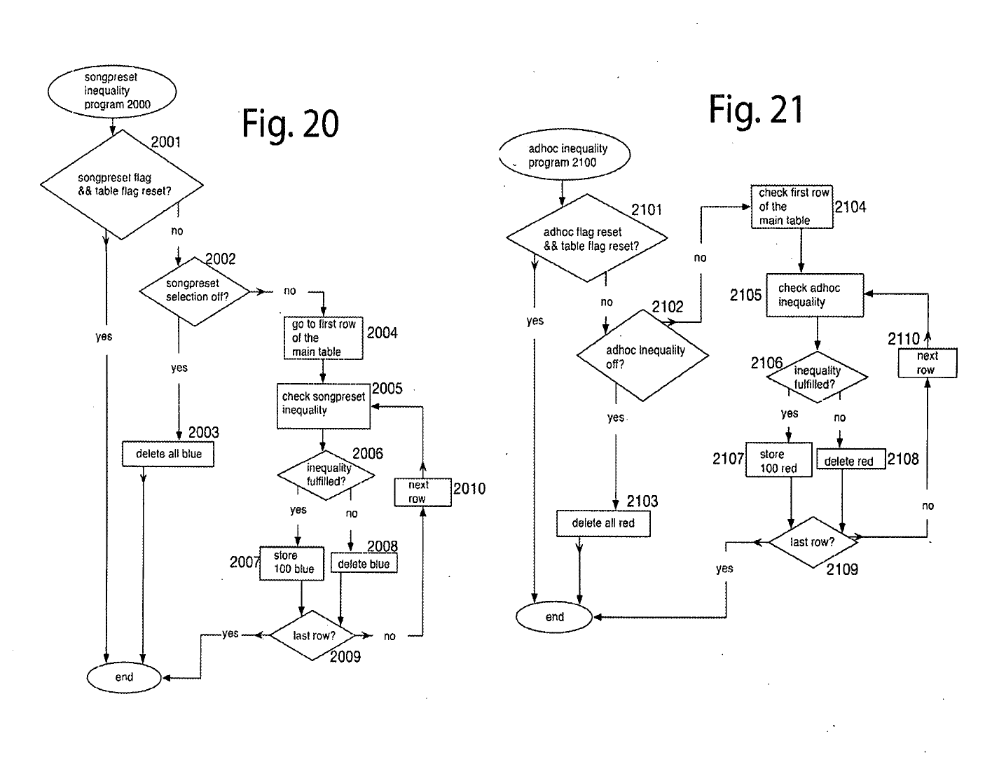

FIG. 20 shows the sub program “songpreset inequality program”

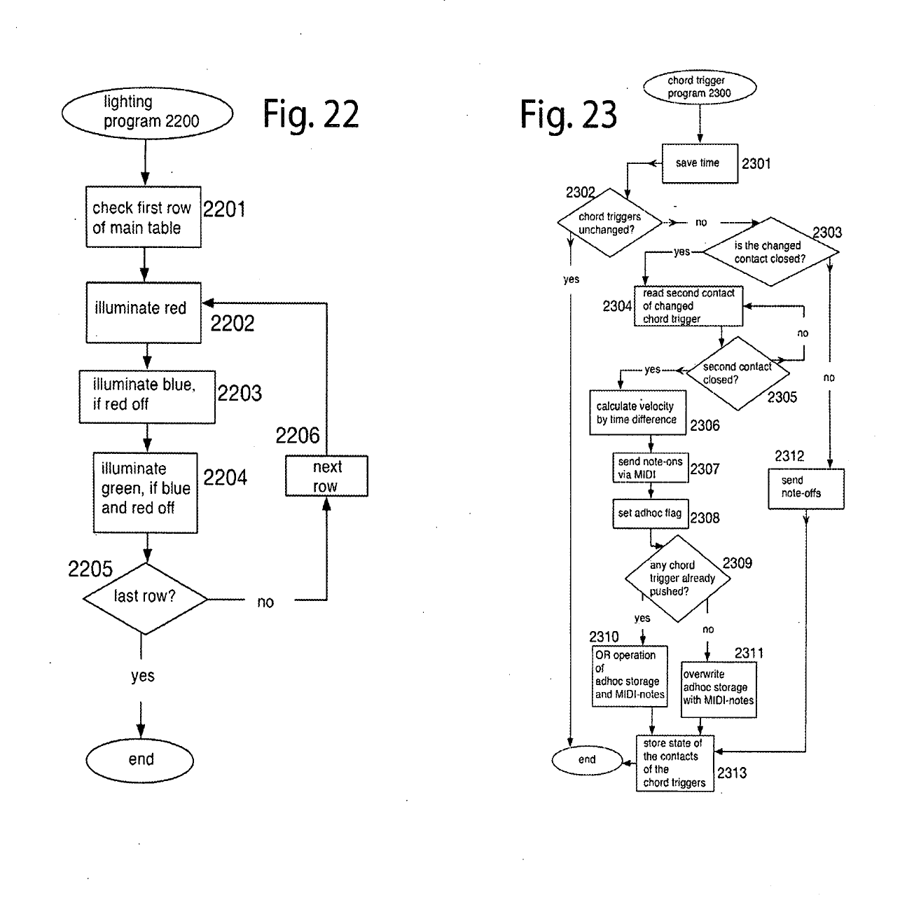

FIG. 21 shows the sub program “adhoc inequality program”

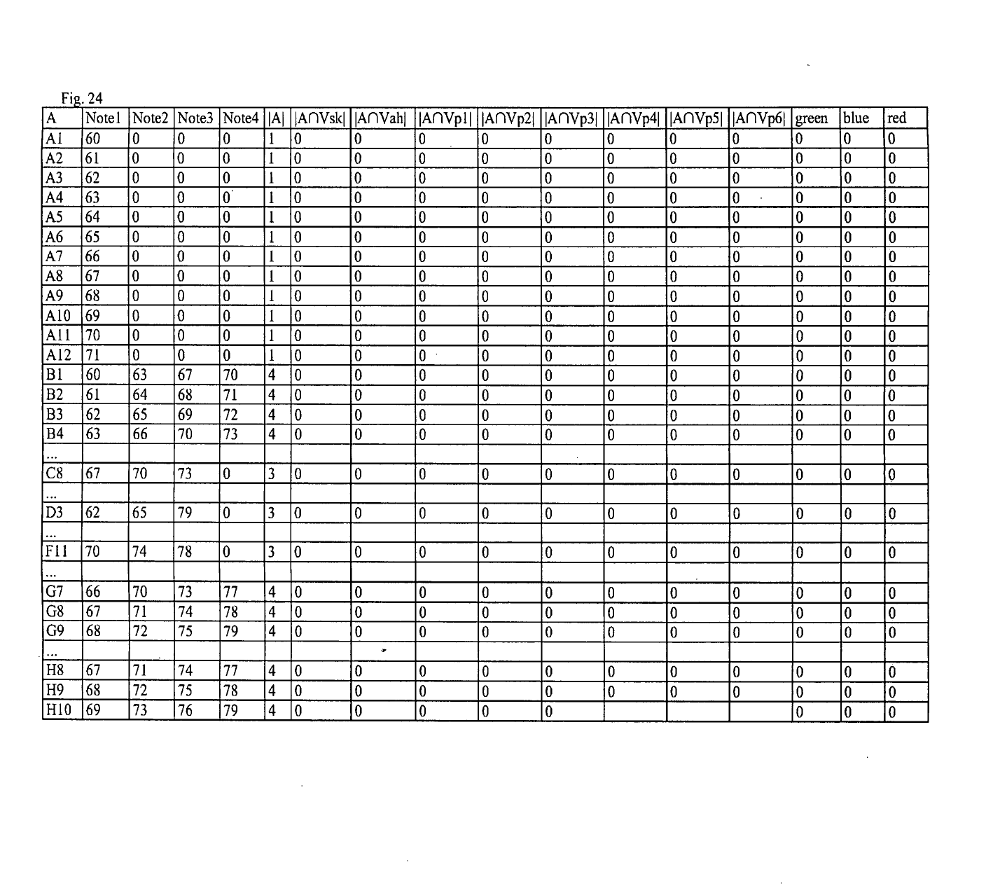

FIG. 22 shows the sub program “lighting program”

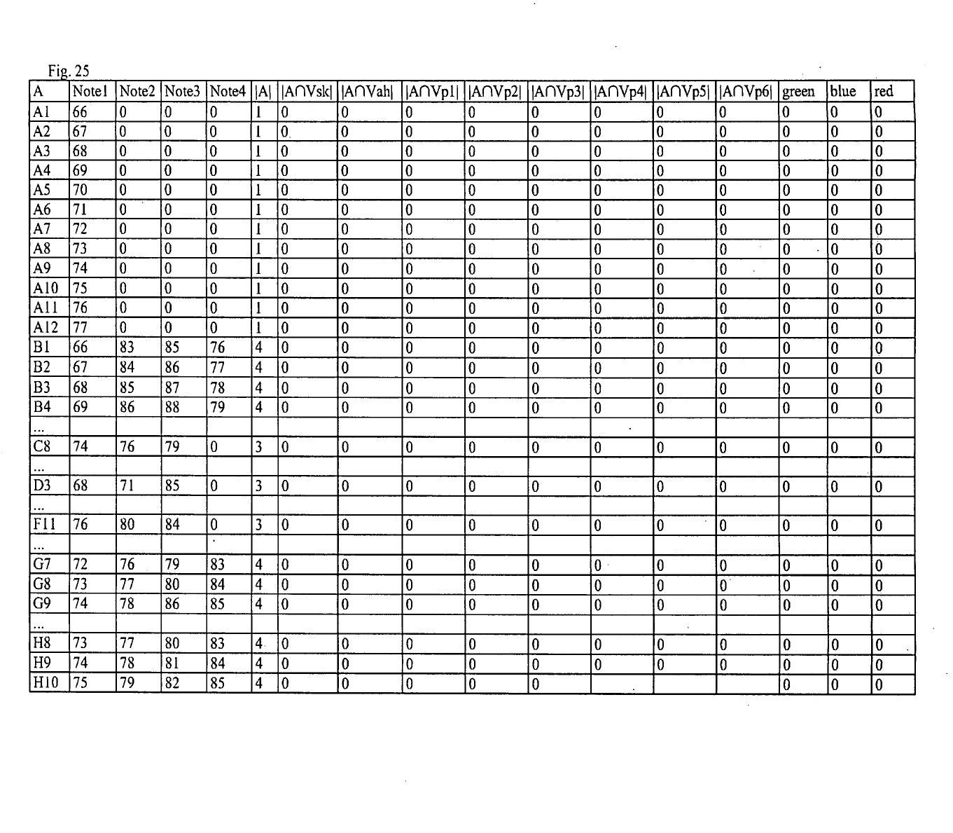

FIG. 23 shows the sub program “chord trigger program”

FIG. 24 shows a sample of the C-start-table which is stored in the computer 105 and can serve as a starting point

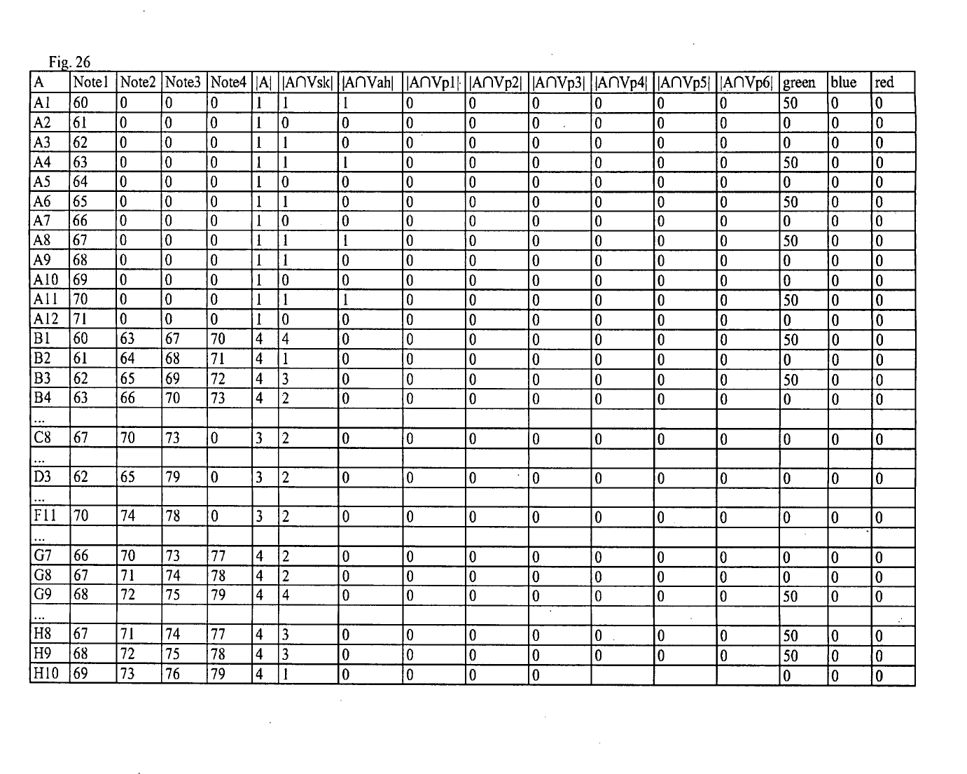

FIG. 25 shows a sample of the C-start table that has been rewritten by the computer 105 to the root note F sharp

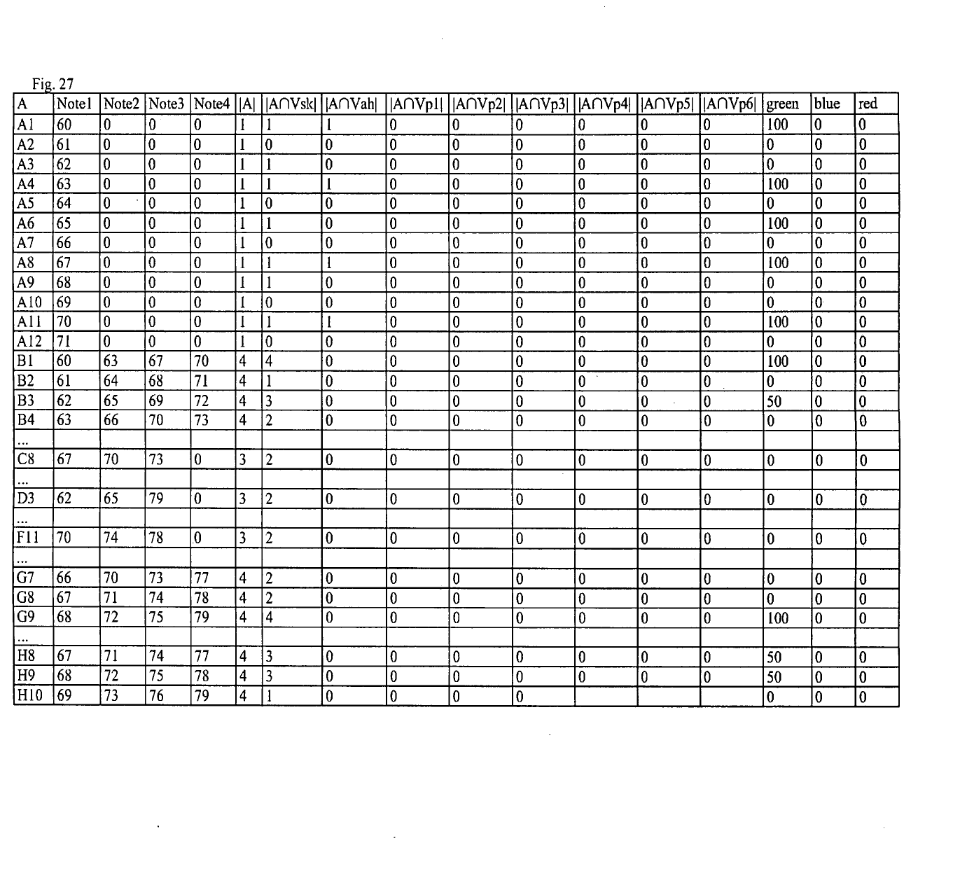

FIG. 26 shows a sample of the C-Start-table, which was provided with an illumination according to FIG. 6

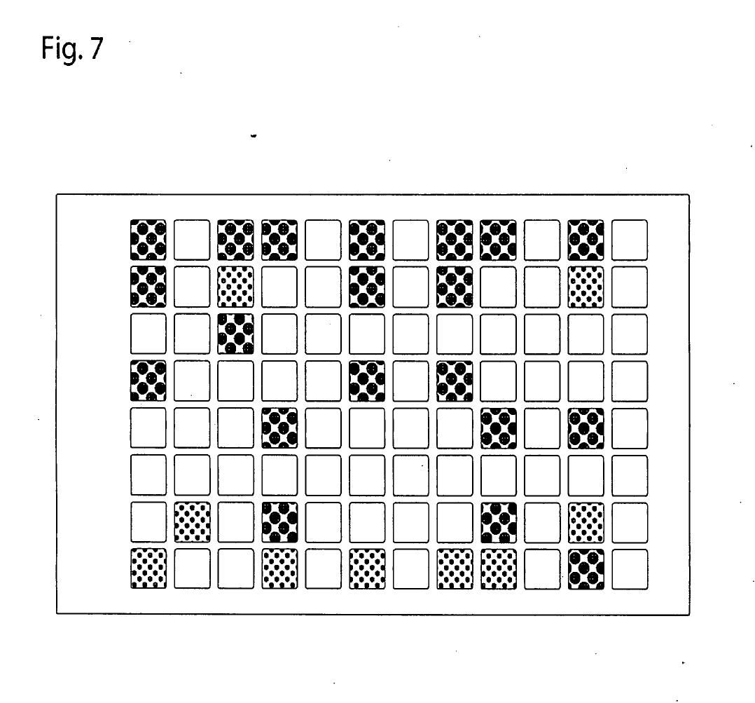

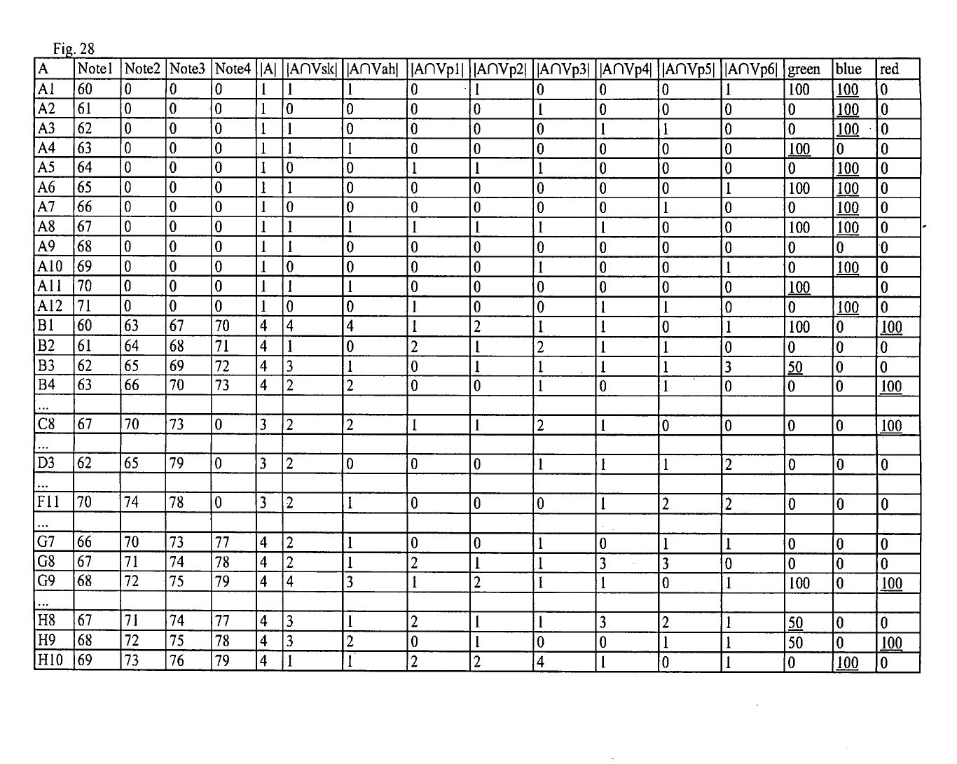

FIG. 27 shows a sample of the C-start-table, which was provided with an illumination according to FIG. 7

FIG. 28 shows a sample of the C-start-table, which was provided with an illumination according to FIG. 11

The chord triggers of the embodiment are buttons with contacts which close electric lines by pushing, to transmit that they are pushed. These buttons are translucent and can be illuminated by RGB LEDs, which are located under the button. All components are located inside or on a common housing, as well as the selection knobs and the alt-button of FIG. 4 and the user interface of FIG. 2.

After the start the note mapping program 1500 begins, wherein it first reads the alt-button 109 in 1501. The alt-button can be on or off. Then in 1502 the root note selection 100 is read. It can be set on 12 different selections, which can define all pitch classes of the chromatic scale from C to B, as shown in FIG. 4.

If it is detected during testing in 1503, that the root note selection 100 and the alt-button 109 still have the same state as in the previous iteration of the loop, the table flag in 1510 is reset and the loop jumps to the scale program 1600. However, if it is detected that the root note selection 100 or the alt-button 109 was changed, the alt-button is stored in 1504, the root note is stored in 1505 and the question is asked in 1506, whether the alt-button is activated. If it is, the C-alt-table which can be seen in FIG. 13, is stored into the main table in 1507, if not, the C-start-table, which can be seen in FIG. 24, is stored at 1508 into the main table.

The C-start-table is made that way, so that all chord triggers of row A are only mapped with single notes, the chord triggers of row B only to min7 chords, C only to dim chords, D only to minor chords, E only to major chords, F only to aug chords, G only to maj7 chords and H only to 7 chords.

The C-alt-table is made that way, so that all chord triggers of row A are only mapped to sus4 chords, B only to minor thirds. C only to dim 7 chords, D only to min6 chords, E only to maj6 chords, F only to aug7 chords, G only to major thirds and H only to power chords.

In addition, in both tables, the mapped specific chords are structured on a way, that in column 1 all are on the root note C, all in 2 on the root note C sharp, all in 3 on thr root note D, and so on in ascending semitones until column 12, in which all mapped specific chords are on the root B.

After loading one of the tables, all midi notes are collectively and uniformly transposed in this main table at 1509, so that the specific chords of the column 1, which base on the musical note of the root selection 100, are mapped to the chord triggers. This means, that to any midi note in the main table, for example with the root note selection C, nothing is added, for C sharp to each MIDI note +1, for D to each it's +2, for D sharp to each it's +3 and so on. In FIG. 25 you can see the case where the root note selection 100 is set to F sharp and so all midi notes were increased by the value 6 in step 1509. The following example is, however, explained with reference to the selection of the root note C. After the uniform transposition, the table flag is set at 1511. Then this sub program goes into its end.

Now it continues with the reading of scale selection 101 in the scale program 1600 at step 1601. It's also checked in 1602, whether the scale selection 101 is remained the same as compared to the check in the previous loop. If nothing has changed, the scale flag is reset at 1606 and the program goes to the songpreset program 1700. The scale selection 101 has the selections of major, minor, and Spanish, as can be seen in FIG. 4. If the result of 1602 is, that the scale selection has changed compared to the last test, so it will be stored as the current scale in 1603 and the scale flag is set in 1604 and in 1605 the cardinality of the intersection of the pitch class of the mapped specific chord of the chord trigger 106 and the pitch class of common scale note repertoire for each chard trigger 106, that means for each row of the main table from the computer 105, is calculated and stored. This calculation for a column of the main table might work in C or C++ like this:

The common note repertoire of the scale is given as a 12-bit code wherein each bit represents one pitch class, the leftmost bit always represents the pitch class C and it is ascending to the right by one semitone, so the bit on the right end represents the pitch class B.

For the C-major scale, for example, like this:

scale_repertoire=101011010101;

For C-Spanish like this:

scale_repertoire=110011011010;

intersection_cardinality is the cardinality of the intersection and it is increased by 1 during the check, which asks, if a pitch class of the mapped specific chord of a chard trigger 106 matches with a pitch class of the common note repertoire.

By the modulo operation with divisor 12, for example, all midi notes of C become 0, all C sharp become 1, and so on, no matter what octave they are. Because all midi notes of the same pitch class are equal concerning their remainder when divided by 12. The number “100000000000” represents a C in this system. This number's bits are shifted to generate the desired musical note from the given C. It is as much shifted as the wanted musical note is steps away in semitones from the C. The distance is the result of the modulo.

The if-conditions, which demand that the pitch classes are not equal to each other, should prevent that those midi notes, which differ only in octaves, are registered as two pitch classes. Additionally it is ensured by an if-statement checking whether the MIDI note does not already have the value 0 without the modulo operation, so that empty midi notes of the value 0 are not counted as pitch class C. The programming code might look like this:

intersection_cardinality = 0;
if (Note1 != 0) && (((100000000000 >> (Note1 % 12)) &
scale_repertoire) != 0) {
intersection_cardinality += 1;
}
if (Note2 != 0) && (((100000000000 >> (Note2 % 12)) &
scale_repertoire) != 0) && (Note2 % 12 != 12
% Note1)) {
intersection_cardinality += 1;
}
if (Note3 != 0) && (((100000000000 >> (Note3 % 12)) &
scale_repertoire) != 0) && (Note3 % 12 !=
Note1 % 12) && (Note3 % 12 != Note2 % 12)) {
intersection_cardinality += 1;
}
if (Note4 != 0) && (((100000000000 >> (Note4 % 12)) &
scale_repertoire) != 0) && (Note4 % 12 !=
Note1 % 12) && (Note4 % 12 != Note2 % 12) && (Note4 %
12 != 12 % Note3)) {
intersection_cardinality += 1;
}

In the case of a C-major chord (for example with the midi notes 60, 64, 67), which is mapped to the chord trigger, and a C-major scale note repertoire the calculation would look like this:

intersection_cardinality = 0;
if (((100000000000 >> (60 % 12)) 101011010101) != 0) {
intersection_cardinality += 1;
}
if (64 != 0) && (((100000000000 >> (64 % 12)) 101011010101)! = 0)
&& (64 % 12 != 60 % 12)) {
intersection_cardinality += 1;
}
if (67 != 0) && (((100000000000 >> (67 % 12)) 101011010101) != 0)
&& (67 % 12 != 60 % 12) && (67
% 12 != 64 % 12)) {
intersection_cardinality += 1;
}
if (0 != 0) && (((>> 100000000000 (0 % 12)) 101011010101) != 0)
&& (0 % 12 != 60 % 12) && (0 %
12 != 64 % 12) && (0 % 12 != 67 % 12)) {
intersection_cardinality += 1;
}

The first 3 conditional statements have fulfilled if-conditions and each can increase “intersection_cardinality” by 1 each, thereby intersection_cardinality has the value of 3 in the end. If that has been calculated and stored for each row of the main table, the scale program goes to its end.

Now at 1701 it continues with the reading of the songpreset selection 103 in the songpreset program 1700. It is also asked here in 1702, whether the songpreset selection 103 is remained the same as compared to the test in the previous loop. If it has not changed, in here the songpreset flag is reset at the 1706. The songpreset selection 103 has the selection of five songs and can be turned off at the sixth position. If the songpreset selection 103 has changed compared to the last test, it will be stored in 1703 and the songpreset flag is set in 1704 the and in 1705 the cardinality of the intersection of the pitch classes of the mapped specific chord of the chord trigger and each common songpreset note repertoire of the common note repertoire group is calculated and stored for each row of the main table. This calculation works on the same principle as the calculation of cardinality of the intersection of the pitch classes of the mapped specific chord of the chord trigger and pitch classes of common scale note repertoire.

Now it starts in the adhoc program of 1800 in 1801 with checking the adhoc flag. The common adhoc note repertoire is set by triggering chord triggers. It will be described later, how this exactly happens. If the adhoc flag Is set, in 1802 the cardinality of the intersection of the pitch classes of the mapped specific chord of the chord trigger and the pitch classes of common adhoc note repertoire for each chord trigger is calculated and stored for each row of the main table. This calculation works on the same principle as the calculation of cardinality of the intersection of the pitch classes of the mapped specific chord of the chord trigger and the pitch classes of the common adhoc note repertoire. If the adhoc flag is not set, it continues with the scale inequality program in 1900.

In addition to scale selection 101, there is a scale inequality selection 102. It has the following options:

1. “|pitch classes of the mapped specific chord of the chord trigger ∩ pitch classes of common scale note repertoire|>=|Pitch classes of the mapped specific chord of the chord trigger|”

This means in words “pitch classes of the mapped specific chord of the chord trigger are subset of the pitch classes of common scale note repertoire”.

An alternative spelling for the inequality would be:

“Pitch classes of the mapped specific chord of the chord trigger ⊂ pitch classes of common scale note repertoire”

2. “|pitch classes of the mapped specific chord of the chord trigger ∩ pitch classes of common scale note repertoire|>70%*|pitch classes of the mapped specific chord of the chord trigger|”

This means in words “more than 70% of the pitch classes of the mapped specific chord of the chord trigger are subset of the pitch classes of common scale note repertoire”

3. “1. |pitch classes of the mapped specific chord of the chord trigger ∩ pitch classes of common scale note repertoire|>=|Pitch classes of the mapped specific chord of the chord trigger|;

2. |Pitch classes of the mapped specific chord of the chord trigger ∩ pitch classes of common scale note repertoire|>70%*|pitch classes of the mapped specific chord of the chord trigger|”

This means in words, that those ones are primarily illuminated, who follow the statement “pitch classes of the mapped specific chord of the chord trigger are subset of the pitch classes of common scale note repertoire” and also the remaining and still not illuminated ones, which match “over 70% of the pitch classes of the mapped specific chord of the chord trigger are subset of the pitch classes of common scale note repertoire”, are also illuminated, but weaker.

4. “|pitch classes of {Note2, Note3, Note4}∩ pitch classes of common scale note repertoire|>=|Pitch classes of {Note2, Note3. Note4}|”

This means in words “pitch classes of the mapped specific chord of the chord trigger without the root note are subset of the pitch classes of common scale note repertoire”.

An alternative spelling for the inequality would be:

“Pitch classes of {Note2, Note3, Note4}⊂ pitch classes of common scale note repertoire”

5. Off

As an example of calculation for selection 1, the following can be used:

We compare chord trigger E5, which is mapped with the C-start-table of the E-major chord, with the common note repertoire of the C-major scale.

The 12-bit code of the mapped specific chord of chord trigger E5 is 000010001001, the code of the C-major scale is 101011010101.

Circuit 1 has the following inequality:

|Pitch classes of the mapped specific chord of the chord trigger ∩ pitch classes of common scale note repertoire|>=|Pitch classes of the mapped specific chord of the chord trigger|

You could computationally describe the inequality for this purpose, for example like this: 000010001001 & 101011010101>=000010001001

The intersection is computed by a logical AND and so the inequality looks like this: 000010000001>=000010001001

That is not true.

Thus, the inequality is not fulfilled.

Selection 3 is the only one which has two inequalities, all the others have only one common mathematical first inequality, and selection 5 has none at all. These two common mathematical inequalities at selection 3 are hierarchical. This means that the color code of the common mathematical first scale inequality wins out over the color code of the common mathematical second scale inequality. That is technically solved by first checking the common mathematical second scale inequality and writing its color code and afterwards checking the common mathematical first scale inequality, which overwrites the color code, if the common mathematical first scale inequality is true.

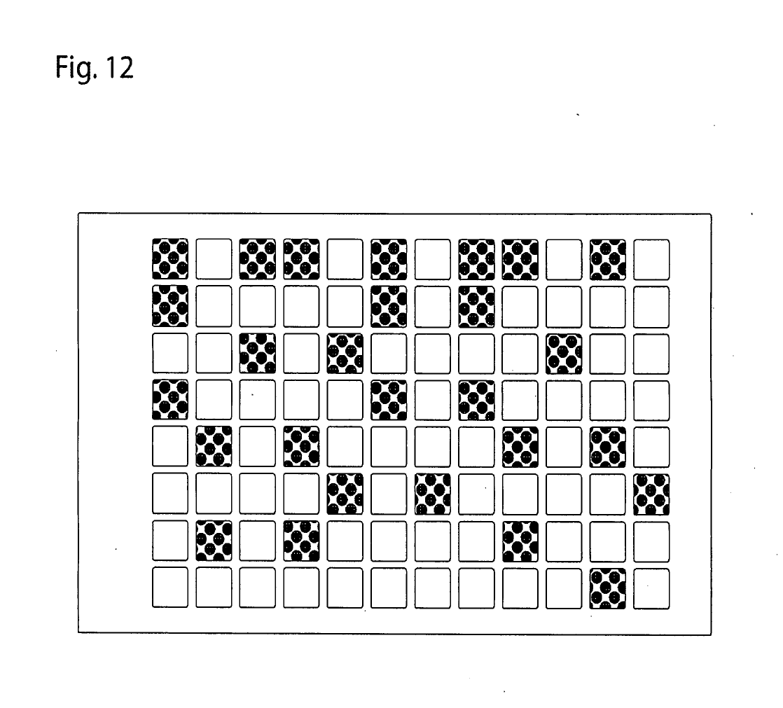

Selection 4 is the only one on which only “Note2” to “Note4” is used, which means all are used except “Note1” as note set of the chard trigger far the check of the inequality. In FIG. 12 it can be seen how the user interface of the setting of scale selection=major and root note selection=C and scale inequality selection=4 (“Without root note 100%”) would look like.

In the scale inequality program 1900 it is checked at 1901, whether the scale flag is reset while the scale inequality selector is not identical to the stored common mathematical scale inequality and the table flag is reset. If that's true, the program continues with the song preset inequality program 2000. If not, the common mathematical scale inequality is stored at 1902 and then it is checked at 1903, whether it is set to “5. Off”. If it is “yes”, all entries in the main table in the “green” column get deleted at 1904 and the program is led to the song preset inequality program 2000. If the scale inequality selection 102 is not set to “5. Off” it is asked in 1905, whether the scale-Inequality selection 102 is set to “3.”, because this is the only position in which a second scale inequality has to be checked. If the answer is “no”, all entries in the main table in the “green” column get deleted in 1914 and the program continues with 1915. But if the answer is “yes”, first the common mathematical second scale inequality is checked. Then the program starts in the first row of the main table by 1906 and runs for each row the check, which calculates the common mathematical inequality in 1907 and it then asks in 1908 whether the common mathematical inequality is fulfilled for the note set of the mapped specific chord of the chord trigger. If this is true, the right color code is stared in the columns of the main table in 1909, wherein the color code is “50 Green” in case of this common mathematical second scale inequality, and the color code will be cleared at 1910, if the fulfillment of the inequality is negative. In order to go through this test far all the lines, in 1911 it is asked after storing the color code, whether the program is in the last row of the main table. If that is answered with “yes”, the check of common mathematical second scale inequality is finished. If it is “no”, the program will continue with the next line by 1912 and starts there with the check of the inequality in 1907. In FIG. 26 an example can be seen where the color code has been stored for the common mathematical second scale inequality of scale C-minor. In FIG. 6 we see how the chard triggers are highlighted in the user interface, in FIG. 5 it can be seen that the lightly greenly illuminated chord triggers 501 (which represents the information “50 Green” of the main table) are marked in the drawing by small puncturing.

In 1915-1920, which is the subsequent check of the common mathematical first scale inequality, it has same procedure like the common mathematical scale-second inequality from 1906 to 1912, except that in 1918 “100 green” is stared instead of “50 Green” as in 1909, whereat an existing entry Is overwritten if the common mathematical inequality is fulfilled, however, the entry stays the same if the inequality is not fulfilled, no matter what the entry is. In FIG. 27 an example is shown where the color codes for the common mathematical second scale inequality and the common mathematical first scale inequality of the C-minor scale were stored. In FIG. 7 we sea how the chord triggers are highlighted on the user interface of FIG. 27, while you see in FIG. 5 the strongly greenly illuminated chord triggers 500 (which represent the information “100 Green”) are marked by large puncturing and the lightly greenly illuminated chord triggers 501 (which represent the information “50 Green”) are marked by small puncturing in the drawing.

Then the songpreset inequality program 2000 starts, which is first asking in 2001, whether the songpreset flag is reset while the table flag is reset. If the answer is “yes” this sub program 2000 is finished, if the answer is “no”, it is checked in 2002 whether the song preset selection 103 is set to “6. Off”. If this is the case, at 2003 the color code “100 Blue” is deleted from all the rows of the main table. If this is not the case, a inequality check from 2004 to 2010 similar to the scale-Inequality program 1900 is run, with the difference that there is no common mathematical second inequality, but six common note repertoires instead of one and that a fulfillment of the inequality of the pitch classes of the mapped specific chord of the chord trigger with one of the common song preset note repertoires is already enough to store an entry of the color code, whereat the common mathematical songpreset inequality is not selectable, but fixed, and equals the first option “100%” of the scale inequality selection 102 and is in here:

“|Pitch classes of the mapped specific chord of the chord trigger ∩ pitch classes of common song preset note repertoire 1|>=|Pitch classes of the mapped specific chord of the chord trigger|”

or

“|Pitch classes of the mapped specific chord of the chord trigger ∩ pitch classes of common song preset note repertoire 2|>=|Pitch classes of the mapped specific chord of the chord trigger|”

or

“|Pitch classes of the mapped specific chord of the chord trigger ∩ pitch classes of common song preset note repertoire 3|>=|Pitch classes of the mapped specific chord of the chord trigger|”

or

“|Pitch classes of the mapped specific chord of the chard trigger ∩ pitch classes of common song preset note repertoire 4|>=|Pitch classes of the mapped specific chord of the chord trigger|”

or

“|Pitch classes of the mapped specific chord of the chord trigger ∩ pitch classes of common song preset note repertoire 5|>=|Pitch classes of the mapped specific chord of the chord trigger|”

or

“|Pitch classes of the mapped specific chord of the chord trigger ∩ pitch classes of common song preset note repertoire 6|>=|Pitch classes of the mapped specific chord of the chord trigger|”

This means in words “The pitch classes of the mapped specific chord of the chord trigger are subset of the pitch classes of at least one common song preset note repertoire”.

You could computationally describe the condition in C/C++ like this:

((“12-bit code of the specific chord of the chord trigger” & “12-bit code of song preset note repertoire 1”>=“12-bit code of the specific chord of the chord trigger”)∥(“12-bit Code of specific chord of the chord trigger” & “12-bit code of song preset note repertoire 2”>=“12-bit code of the specific chord of the chord trigger”)∥(“12-bit code of the specific chord of the chord trigger”& “12-bit code of song preset note repertoire 3”>=“12-bit code of the specific chord of the chord trigger”)∥(“12-bit code of the specific chord of the chord trigger” & “12-bit code the song preset note repertoire 4”>=“12-bit code of the specific chord of the chord trigger”)∥(“12-bit code of the specific chord of the chord trigger “&” 12-bit code of song preset note repertoire 5”>=“12-bit code of the specific chord of the chord trigger”)∥(“12-bit code of the specific chord of the chord trigger” & “12-bit code of song preset note repertoire 6”>=“12-bit code the specific chord of the chord trigger”))

In the example, the common note repertoire group “songpreset 1” contains the following common songpreset note repertoires:

E-minor, C-major, A7, G-major, B-minor, F-major

The example of C/C++ would create the following inequalities for the combination of “songpreset 1” and a chord trigger of C-major, as a condition for highlighting:

((100010010000 & 000010010001>=100010010000)∥

(100010010000 & 100010010000>=100010010000)∥

(100010010000 & 010010010100>=100010010000)∥

(100010010000 & 001000010001>=100010010000)∥

(1000100100000 & 001000100001>=100010010000)∥

(100010010000 & 100001000100>=100010010000))

The condition would be fulfilled, because the inequality of the second row is right.

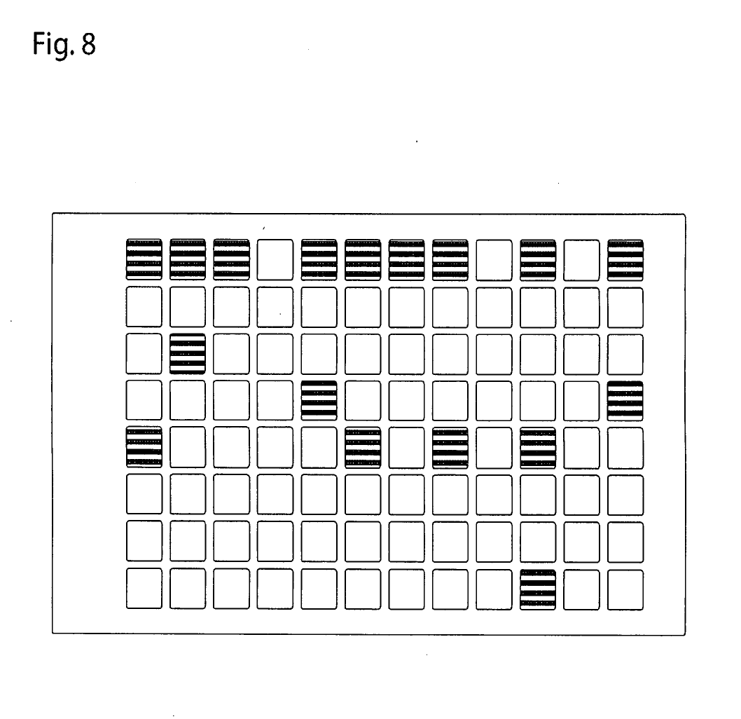

In FIG. 8 you can see how the chord triggers are highlighted in the user interface, while in FIG. 5 it can be seen that the lightly bluely illuminated chord triggers 502 (which represent the information “100 blue”) are marked by horizontal lines in the drawing in. In FIG. 8 the scale selection and the adhoc inequality selection is set off.

Then the program loop continues with the adhoc inequality program in 2100, where from 2101-2110 it is processing by the same way like the song preset inequality program 2000 from 2001 to 2010, with the difference that there is only one note repertoire in the adhoc inequality program like it is in the scale inequality program.

The inequality is this:

|Pitch classes of the mapped specific chord of the chord trigger ∩ pitch classes of common adhoc note repertoire|>=2

This means in words “The pitch classes of the mapped specific chord of the chord trigger and the pitch classes of common adhoc note repertoire have at least 2 matching pitch classes.”

If the adhoc inequality program 2000 was processed, the lighting program begins in 2100.

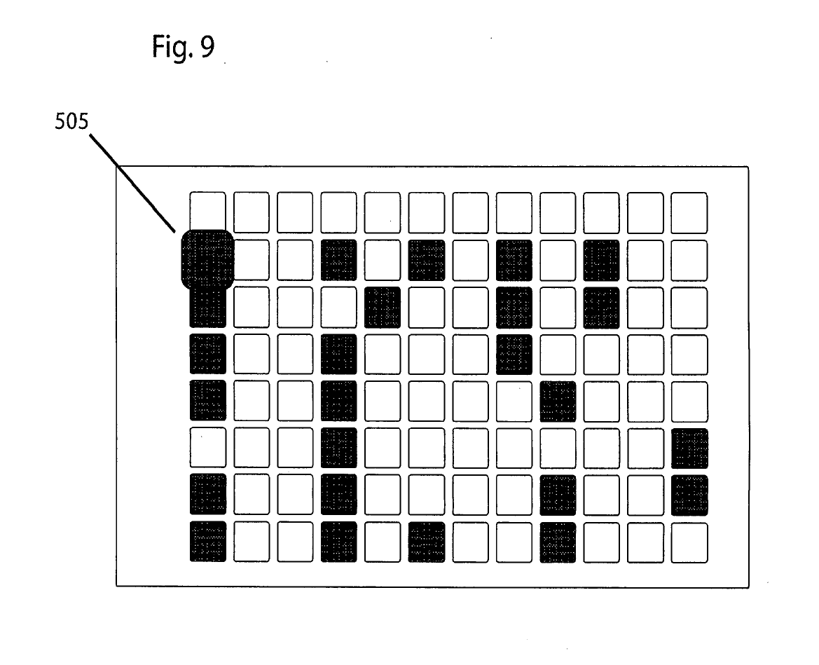

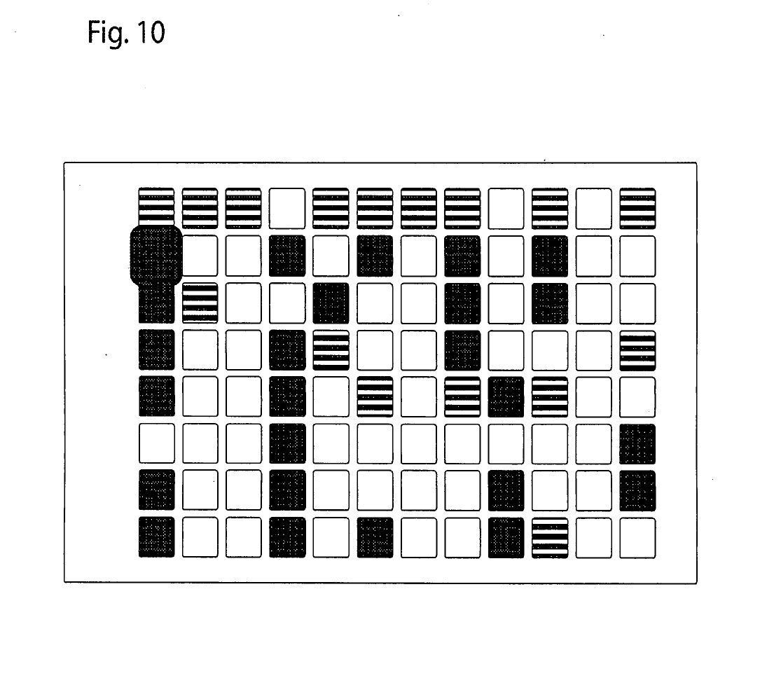

In FIG. 28 there is the example, where the color codes for the common mathematical second scale inequality and the common mathematical first scale inequality of the specific scale C-minor were stored by selection 3 of the scale selection 101, as well as for the common mathematical song preset inequality of the common note repertoires E-minor, C-major. A7, G-major, B-minor, F-major and for the common mathematical adhoc inequality of chord trigger B1, to which in this example a C-min7 chord is mapped by the C-start table. In FIG. 11 you can see how the chord triggers behave on the user interface according to FIG. 18, wherein the completely black chord triggers 503 represent the red lights. FIG. 10 shows this state without considering the green lighting, FIG. 9 shows this state with pure consideration of the red illumination. The blackly overfilled chord trigger 505 represents the currently triggered chord trigger in the drawing. By this overfilled chord trigger the adhoc storage is stored.

Then the LED light states are updated and maintained in the lighting program 2200 on the basis of the entries in the main table as familiar for experts, for example, with cascaded shift registers (eg 74HC595), which get an 8-bit signal from the main chip and keep this signal and pass it to the next shift register as soon as they get a new 8-bit signal on their input. The update happens like this: First the program looks on the first row of the main table in 2201 and switches on the red LED of the chord trigger of the checked row of the main table in 2202, if the column named red has the entry “100” and the program switches off the red LED if the entry is “0”. In 2203, the blue LED of the chord trigger of the checked row of the main table is switched on, if the column named blue has the entry “100” and the column Red is set to “0”, and switched off if the column named blue has the entry “O”, or column Red is not set to “0”, in 2204 the chord trigger which is checked in the row of the main table, the green LED is fully switched on, if the column named green has the entry “100” and the column named red and blue are “0”. The green LED is weakly switched on, if the column named green has the entry “50” and the red and blue columns are “0”, and switched off if the green column has the entry “0”, or the columns of red or blue are not set to “0”.

Afterwards the chord trigger program 2300 starts. In order to save ports, it makes sense to multiplex these. In addition, each chord trigger has two electric contacts in order to generate the velocity by the time difference of the closing of the two electric contacts, as known by a skilled person. This can for example also be done via force sensing resistors. In 2301 the time is stored. If the result of 2302 is that everything has remained as in the previous loop concerning closed and unclosed contacts, the program loop goes in its end. However, if a change has occurred, it is checked in 2303 whether the changed contact is now closed. If that is not true, in 2312 a MIDI-off signal is sent which represents the musical notes, which are mapped to this chord trigger as stored in the main table. After that the program loop stores the current state of the contacts of all chord triggers at 2313 and then it goes to its end. If this is true, however, the second contact of the chord trigger is read that often in 2304 until the question “second contact closed?” is “yes” in 2305. Always it is “no”, it is directed back again to the reading of the second contact in 2304. Subsequently in 2306, the time difference of the closed two contacts are computed. This time difference is now converted to a MIDI velocity value and is sent in the tripartite MIDI messages of a) note-on status byte “144”, b) pitch “0-127” and c) velocity 1-127 for each musical note of the mapped specific chord of the chord trigger in 2307. For the chord trigger Dl of the C-start-table the following bytes would be sent, if it is moderately pressed, wherein the value 90 of 127 represents an example of moderate velocity:

144

90

60

144

23

90

63

144

90

67

Then the adhoc flag is set at 2308.

If the question 2309 is asked, whether a chord trigger has already been pressed, which still could not generate a MIDI-off signal by releasing the chord trigger, and this question is answered with “yes”, the common adhoc note repertoire and the pitch classes of the mapped specific chord of the newly triggered chord trigger are processed by an OR operation in the common adhoc storage, otherwise they are overwritten.

To process this the mapped musical notes of the newly triggered chord trigger are coded in a 12-bit code, as previously similarly explained. A C-major chord, for example, would have the code “100010010000”, a D-minor for example “001001000100”.

So C-major and D-minor would have the result “101011010100”, if processed by an OR operation. After that the current state of all the chord triggers is stored at 2313 and the loop ends. Then the main program of FIG. 14 starts from the beginning.

Now several properties of further alternative embodiments are expressed.

Of course, with an alternative embodiment, the invention could even work without calculating the fulfillment of the inequality, for example, if the results are stored for each case as precomputed stared data, eg in tables. Depending on the memory capacity and computing speed, an optimal design can be selected. Also all mixed variants of systems with stored pre-calculations and systems which calculate everything spontaneously, are imaginable. Clearly, a system, which is strongly based on calculation, which works without pre-calculations, can be used much more openly and therefore parameters can be easierly changed, such as the mapped specific chords of the chord triggers or the common note repertoires. Thereby openness and variability of system are guaranteed.

Of course, also an alternative embodiment could comprise chord triggers, for example, which are light sensors, heat sensors, touch screen/touchpad (resistive, capacitive, inductive, optical, etc), infrared tracking, video tracking or wherein the chord triggers are eg visually-existent and highlighted by that, but can be triggered by voice input if you call the assigned numbers or the name of their chord such as C-major. The highlighting could work, for example, by vibration, heat, finish, shape, charge current/low voltage, movement, increasing buttons and so on instead of LEDs. The outputting of specific chords, for example, could work by MIDI, OSC, an audio signal or directly by a speaker, creating the sounds of an acoustic instrument, generating a score sheet, displaying the music on a display, control voltage connections with voltages of specific chords and so on. These are all examples to make clear what would be possible. However, these examples are not intended to be the limits of the present invention, but that shall only be the abstract formulation of the main claim.

Of course, those highlighting methods are preferable, in which the highlighting of each chord trigger is as precise, separate and completely perceivable as possible. Acoustic highlighting makes little sense, for example, because they blur with output musical notes and because they can become blurred in their simultaneous perception among themselves. The best way is the visual highlighting, because thereby mare chord triggers can be accurately and distinguishably perceived at once than on highlighting with heat, vibration and so on. Despite the favored highlighting method of the visual, the patent claims all highlighting methods.

The output of the specific chords can be done simultaneously or sequentially, for example by arpeggios or strumming.

Of course, the chord triggers may be arranged with or without a scheme, they can be arranged in order or in chaos on the user interface and also mapped with or without a scheme, for example randomly mapped. The number of chord triggers is of course almost unlimited. The mapping could, if it is schematically arranged, be arranged in fifths, fourths or thirds instead of semitones like in the embodiment.

In addition, it is absolutely imaginable in an alternative embodiment, that the device is a software for an existing hardware system (eg personal computer, mobile, tablet, music controller, . . . ), which could be used via any imaginable input method such as a mouse, touchscreen, MIDI controller, musical keyboard, computer keyboard, touchpad, voice input, . . . instead of a standalone hardware.

If an embodiment has a matrix, this also can, of course, have more than two dimensions. A three-dimensional matrix could for example be used via video tracking with hands on a grid-cube, wherein the three indices could be eg root note, chord type and for example, voicing or strumming.

However, the absolute minimum of chord triggers of the invention are four chord triggers to comply with the following part of the main claim: “wherein the simultaneously triggerable chord triggers comprise at least two chord triggers, whose pitch classes of the mapped specific chord only differ in uniform transposition of the pitch classes,

wherein the simultaneously triggerable chard triggers comprise at least three chord triggers, whose pitch classes of the mapped specific chord differ but not only in uniform transposition of the pitch classes, . . . ” An example might be: Chord trigger 1 is mapped to the C-minor chord, chord trigger 2 to the G-major chord and chord trigger 3 to the F-min7 chard, chord trigger 4 to the C sharp minor.

The mapped specific chords, which are mapped to chord trigger 1, 2 and 3, differ but not in only uniform transposition of their pitch classes.

The mapped specific chords, which are mapped to chord trigger 1 and 4, differ only in the uniform transposition of their pitch classes, because all pitch classes are uniformly transposed by one semitone to create one specific chord by the other.

Additionally the inequality has not be pointed out in any way. It is enough, if the highlighting represents such an inequality to be protected by the claims of this patent.

1. Musical instrument, which comprises chord triggers, that are simultaneously triggerable and that are each mapped to a specific chord, which consists of several musical notes of various pitch classes,
wherein the musical instrument outputs the mapped specific chord or an arpeggio of this mapped specific chord by triggering one of the chord triggers,
wherein the simultaneously triggerable chord triggers comprise at least two chord triggers, whose pitch classes of the mapped specific chord only differ in uniform transposition of the pitch classes,
wherein the simultaneously triggerable chord triggers comprise at least three chord triggers, whose pitch classes of the mapped specific chord differ but not only in uniform transposition of the pitch classes,
characterized by means which put 80-100% of the set of the simultaneously triggerable chord triggers of the musical instrument in the state, in which those chord triggers,
whose mapped specific chord fulfills a common mathematical inequality, which compares a threshold with the cardinality of the intersection of the pitch classes of the mapped specific chord and the pitch classes of a common note repertoire,
are highlighted distinguishably differently from the chord triggers whose mapped specific chord does not fulfill this inequality.

2. A musical instrument according to claim 1,
wherein the mathematical inequality is:
“|Pitch classes of the mapped specific chord of the chard trigger ∩ pitch classes of the common note repertoire|>=a*|Pitch classes of the mapped specific chord of the chord trigger|” with “⅓<a<=1”
or
“|Pitch classes of the mapped specific chord of the chard trigger ∩ pitch classes of the common note repertoire|>=|Pitch classes of the mapped specific chord of the chord trigger|−a” with “0<=a<=2”
or
“|Pitch classes of the mapped specific chord of the chord trigger ∩ pitch classes of the common note repertoire|>=a” with “2=a<=3”
or
“a<=|pitch classes of the mapped specific chord of the chord trigger ∩ pitch classes of the common note repertoire|>=|Pitch classes of the mapped specific chord of the chord trigger|−b” with “2<=a<=3” and “0<=b<=2”
or
“a*|pitch classes of the mapped specific chord of the chord trigger|<=|Pitch classes of the mapped specific chord of the chord trigger ∩ pitch classes of the common note repertoire|>=b” with “⅓<a<=1” and “2<=a<=3”
or
“a*|pitch classes of the mapped specific chord of the chord trigger|<=|Pitch classes of the mapped specific chord of the chord trigger ∩pitch classes of the common note repertoire|>=|Pitch classes of the mapped specific chord of the chord trigger|−b” with “⅓<a<=1” and “0<=b<=2”

3. A musical instrument according to claim 2, wherein the chord triggers are arranged in a matrix of any dimensionality, in which each chord trigger is an element of the matrix and the mapped specific chord of each chord trigger logically results from the combination of indexes, wherein one index determines the root note and a different index the chord type.

4. A musical instrument according to claim 3,
wherein the at least three chord triggers that differ in terms of pitch classes from the mapped specific chord but not by the uniform transposition of the pitch classes, are such that the mapped specific chord of the one chord trigger is a minor chord, another is a major chord, and the third is a diminished chard wherein the highlighting is visual,
wherein the common note repertoire is a conventional specific note scale or a conventional specific chord of the western chromatic music system,
wherein the chord triggers are real or virtual buttons and are triggered by pushing.

5. A musical instrument according to claim 4, wherein the common note repertoire is settable by the selection of a note repertoire out of various note repertoires, whose pitch classes differ but not only in uniform transposition of their pitch classes.

6. A musical instrument according to claim 3, wherein the common mathematical inequality sets how much percentage “a” of the mapped specific chord of the chord trigger is included in the common note repertoire, which can be mathematically expressed like this:

|Pitch classes of the mapped specific chord of the chord trigger ∩ pitch classes of the common note repertoire|>a*|Pitch classes of the mapped specific chord of the chord trigger| with “⅓<a<=1”.

7. A musical instrument according to claim 6, wherein the means put 95-100% of the mentioned set in the mentioned state.

8. A musical instrument according to claim 6, wherein the means put 100% of the mentioned set in the mentioned state.

9. Musical instrument, which comprises chord triggers, that are simultaneously triggerable and that are each mapped to a specific chord, which consists of several musical notes of various pitch classes,
wherein the musical instrument outputs the mapped specific chord or an arpeggio of this mapped specific chord by triggering one of the chord triggers,
wherein the simultaneously triggerable chard triggers comprise at least two chord triggers, whose pitch classes of the mapped specific chord only differ in uniform transposition of the pitch classes,
wherein the simultaneously triggerable chord triggers comprise at least three chord triggers, whose pitch classes of the mapped specific chord differ but not only in uniform transposition of the pitch classes,
characterized by means which put 80-100% of the set of the simultaneously triggerable chord triggers of the musical instrument in the state, in which those chord triggers,
whose mapped specific chord fulfills together with at least one common note repertoire out of a group of common note repertoires a common mathematical inequality, which compares a threshold with the cardinality of the intersection of the pitch classes of the mapped specific chord and the pitch classes of a common note repertoire out of a group of common note repertoires,
are highlighted distinguishably differently from the chord triggers whose mapped specific chord does not fulfill this inequality,
wherein the common note repertoire includes up to five pitch classes,
wherein the group of common note repertoires is not changeable by triggering a chord trigger.

10. A musical instrument according to claim 9, wherein the common mathematical inequality sets how much percentage “a” of the mapped specific chord of the chord trigger is included in common note repertoire, which can be mathematically expressed like this:

|Pitch classes of the mapped specific chord of the chord trigger ∩ pitch classes of the common note repertoire|>a*|Pitch classes of the mapped specific chord of the chord trigger| with “⅓<a<=1”.

11. A musical instrument according to claim 10, wherein the chord triggers are arranged in a matrix of any dimensionality, in which each chord trigger is a element of the matrix and the mapped specific chord of each chord trigger logically results from the combination of indexes, wherein one index determines the root note and a different index the chord type.

12. A musical instrument according to claim 11, wherein the means put 100% of the mentioned set in the mentioned state.

13. Musical instrument, which comprises chord triggers on a user interface of the musical instruments,
wherein these chord triggers are simultaneously triggerable and that are each mapped to a specific chord, which consists of several musical notes of various pitch classes,
wherein the musical instrument outputs the mapped specific chord or an arpeggio of this mapped specific chord by triggering one of the chord triggers,
wherein there is a rectangular inclusion set, which consists of at least 12 simultaneously triggerable chard triggers, which are located inside the area, which is defined by a conceivable convex rectangle projected on the user interface, wherein this rectangular inclusion comprises on the one hand at least two chord triggers, whose pitch classes of the mapped specific chord only differ in uniform transposition of the pitch classes, and on the other hand at least two chord triggers, whose pitch classes of the mapped specific chord differ but not only in uniform transposition of the pitch classes,
characterized by means which put 80-100% of the rectangular inclusion set in that state, in which those chord triggers,
whose mapped specific chord fulfills a common mathematical inequality, which compares a threshold with the cardinality of the intersection of the pitch classes of the mapped specific chord and the pitch classes of a common note repertoire,
are highlighted distinguishably differently from the chord triggers whose mapped specific chord does not fulfill this inequality.

14. A musical instrument according to claim 13,
wherein the mathematical inequality
“|Pitch classes of the mapped specific chord of the chord trigger ∩ pitch classes of the common note repertoire|>=a*|Pitch classes of the mapped specific chord of the chord trigger|” with “⅓<a<=1”
or
“|Pitch classes of the mapped specific chord of the chard trigger ∩ pitch classes of the common note repertoire|>=|Pitch classes of the mapped specific chord of the chord trigger|−a” with “0<=a<=2”
or
“|Pitch classes of the mapped specific chord of the chord trigger ∩ pitch classes of the common note repertoire|>=a” with “2<a<=3”
or
“a<=|pitch classes of the mapped specific chord of the chord trigger ∩ pitch classes of the common note repertoire|>=|Pitch classes of the mapped specific chord of the chord trigger|−b” with “2<=a<3” and “0<=b<=2”
or
“a*|pitch classes of the mapped specific chord of the chord trigger|<=|Pitch classes of the mapped specific chord of the chord trigger ∩ pitch classes of the common note repertoire|>=b “with” ⅓<a<=1” and “2<=a<=3”
or
“a*|pitch classes of the mapped specific chord of the chord trigger|<=|Pitch classes of the mapped specific chord of the chord trigger ∩ pitch classes of the common note repertoire|>=|Pitch classes of the mapped specific chard of the chord trigger|−b” with “⅓<a<=1” and “0<=b<=2”
is.

15. A musical instrument according to claim 14, wherein the rectangular inclusion set consists of at least 16 chord triggers, which are located inside the area, which is defined by a conceivable convex rectangle projected on the user interface.

16. A musical instrument according to claim 15, wherein the means put 100% of the mentioned set in the mentioned state.

17. A musical instrument according to claim 16, wherein the chord triggers are arranged in a matrix of any dimensionality, in which each chord trigger is a element of the matrix and the mapped specific chord of each chord trigger logically results from the combination of indexes, wherein one index determines the root note and a different index the chord type.

18. A musical instrument according to claim 17, wherein the common mathematical inequality sets how much percentage “a” of the mapped specific chord of the chord trigger is included in common note repertoire, which can be mathematically expressed like this:

|Pitch classes of the mapped specific chord of the chord trigger ∩ pitch classes of the common note repertoire|>a*|Pitch classes of the mapped specific chord of the chord trigger| with “⅓<a<=1”.

19. A musical instrument according to claim 17,
wherein the at least three chord triggers that differ in terms of pitch classes from the mapped specific chord but not by the uniform transposition of the pitch classes, are such that the mapped specific chord of the one chord trigger is a minor chord, another is a major chord, and the third is a diminished chord wherein the highlighting is visual,
wherein the common note repertoire is a conventional specific note scale or a conventional specific chord of the western chromatic music system,
wherein the chord triggers are real or virtual buttons and are triggered by pushing.

20. A musical instrument according to claim 19, wherein the common note repertoire is settable by the selection of a note repertoire out of various note repertoires, whose pitch classes differ but not only in uniform transposition of their pitch classes.
